(19) United States
(12) Patent Application Publication
(10) Pub. No.: US 2017/0103111 A1
(43) Pub. Date: Apr. 13, 2017

(54) SYSTEMS AND METHODS FOR MULTI-DIMENSIONAL COMPUTER-AIDED SEARCHING

(71) Applicant: TIIKO, L.L.C., St. Louis, MO (US)

(72) Inventors: Mary Ann Lavin, St. Louis, MO (US); Brendan Michael Keating, St. Louis, MO (US); Stephanie Klien O'Donnell, Tampa, FL (US); Cory Flanagin, Arlington, VA (US)

(21) Appl. No.: 15/290,735

(22) Filed: Oct. 11, 2016

Related U.S. Application Data
(60) Provisional application No. 62/239,132, filed on Oct. 8, 2015.

(51) Int. Cl. G06F 17/30

(52) U.S. Cl. CPC G06F 17/30554; G06F 17/30867; G06F 17/30572

(57) ABSTRACT

Systems and methods for multi-dimensional computer-aided searching. Computer software forms permutation searches based on topical and categorical data provided via user input. The permutation searches are sequenced to a third party database and the results are used to form a multi-dimensional visualization of the total body of resulting data. Via a graphical user interface and a typically polyhedral multi-dimensional visualization, a large amount of meta-data about the content of the search results can be conveyed via the visualization. The searcher may then use the display to access permutation search results for relevant intersections.

### CROSS-REFERENCE TO RELATED APPLICATIONS

This application claims benefit of U.S. Provisional Patent Application No. 62/239,132, filed Oct. 8, 2015, the entire disclosure of which is herein incorporated by reference.

### BACKGROUND

1. Field of the Invention

This disclosure is related to the field of computer-aided searching, and more particularly to systems and methods for multi-dimensional searching.

2. Description of the Related Art

Information and knowledge are limited by the tools through which they are structured. A library of books containing the sum of all human knowledge is useless unless the particular book desired can be readily found and understood. Many of the fundamental developments of human civilization can pertain to improving on this basic need, from alphabets to written language, from stone tablets to papyrus scrolls to bound books, and from the printing press to the paperless digital book of the modern era, appropriately dubbed the “information age” due to the Internet's capacity to place virtually any knowledge or information at one's fingertips in seconds.

The vast majority of existing commercial computer databases, and the search engines that allow access to them, use the same basic input/output paradigm. The user enters a search string into a text box, clicks a “search” button (or otherwise indicates that the user has finished entering the search string), the search engine then searches a database for results that match the search criteria, and a list of such results is displayed in linear fashion to the user, generally according to sonic sort of ranking, such as relevance as determined programmatically by the search engine.

Thus, although we retrieve data and information, including natural language data and information, over a computer network, we still consume it much the same way our ancestors did long ago on a stone tablet or papyrus scroll—sequentially, one page at a time, leaving it up to the user to organize and/or deconstruct the information provided. These limitations exist in part because search engines depend on controlled vocabularies, classifications, taxonomies, ontologies, and knowledge systems to index subject matter.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is a computer-implemented method for generating a multi-dimensional visualization of a computer-aided database search result set comprising: providing a user device; providing a server computer; providing a search engine; receiving at the user device one or more indications of a knowledge domain; for each received indication of a knowledge domain in the one or more indications of a knowledge domain: receiving at the user device an indication of one or more categories for the each indication of a knowledge domain; for each combination of the one of more received categories in the one or more received knowledge domains, the computer server generating a permutation search string having search criteria comprising the categories in the each combination; executing each of the permutation search strings via the search engine; for each of the executed permutation search strings, receiving at the computer server a corresponding search result set; displaying on a display of the user device a multi-dimensional visualization of the each corresponding search result set.

In an embodiment, the multi-dimensional visualization is a geometric object selected from the group consisting of: a polyhedron; a prism; an n-dimensional polytope.

In a further embodiment, each axis of the geometric object corresponds to one of the one or more indicated knowledge domains.

In a still further embodiment, the geometric object comprises a plurality of cells, each one of the cells corresponding to one of the each corresponding search result sets.

In a still further embodiment, the number of the cells on the each axis is equal to the quantity of the one or more indicated categories for the one of the one or more indicated knowledge domains corresponding to the each axis.

In a still further embodiment, the method further comprises: in response to receiving at the user device a user action indicative of one cell in the plurality of cells, displaying at the user device the each corresponding search result set for the indicated one cell.

In another embodiment, the geometric object is an n-dimensional polytope and the n-dimensional polytope polytope is a hypercube having n dimensions.

In another embodiment, the geometric object is an irregular polyhedron in the configuration of a prism having an n-sided base, where n corresponds to the quantity of knowledge domains in the one or more indicated knowledge domains.

Also described herein, among other things, is a system configured to generate a multi-dimensional visualization of a computer-aided database search result set comprising: a user device; a server computer comprising a microprocessor and a non-transitory computer-readable storage medium having computer-readable instructions thereon which, when executed by the microprocessor, perform the steps of: receiving via, a telecommunications network from the user device data indicative of a plurality of user-supplied knowledge domains and, for each knowledge domain in the plurality of knowledge domains, a plurality of categories; for each combination of categories in the plurality of categories in the plurality of knowledge domains, generating a permutation search string having search criteria comprising the categories in the each combination; executing each of the permutation search strings via a search engine; for each of the executed permutation search strings, receiving a corresponding search result set; generating a data object comprising the each corresponding search result set, the data object configured to be displayed on the user device; transmitting the generated data object to the user device.

In an embodiment, the user device comprises a microprocessor and a non-transitory computer-readable storage medium having computer-readable instructions thereon which, when executed by the user device microprocessor, display the generated data object as a geometric object in a multi-dimensional visualization.

In another embodiment, the geometric object selected from the group consisting of: a polyhedron; a prism; an n-dimensional polytope.

In a further embodiment, each axis of the geometric object corresponds to one of the plurality of knowledge domains.

In a still further embodiment, the geometric object comprises a plurality of cells, each one of the cells corresponding to one of the each corresponding search result sets.

In a further embodiment, the number of the cells on the each axis is equal to the quantity of the one or more indicated categories for the one of the plurality of knowledge domains corresponding to the each axis.

In a further embodiment, the user device instructions, when executed by the user device microprocessor, further perform the step of, in response to receiving at the user device a user action indicative of one cell in the plurality of cells, displaying at the user device the each corresponding search result set for the indicated one cell.

In a further embodiment, the geometric object is an n-dimensional polytope and the n-dimensional polytope is a hypercube having n dimensions.

In a further embodiment, the geometric object is an irregular polyhedron in the configuration of a prism having an n-sided base, where it corresponds to the quantity of knowledge domains in the one or more indicated knowledge domains.

Also described herein, among other things, is a system configured to generate a multi-dimensional visualization of a computer-aided database search result set comprising: a user input means; a means for receiving from a user data indicative of a plurality of knowledge domains and, for each knowledge domain in the plurality of knowledge domains, a plurality of categories; a means for generating a plurality of permutation search strings, each one of the plurality of permutation search strings being a different combination of categories in the plurality of categories in the plurality of knowledge domains; a means for executing permutation search string in the plurality of permutation search strings via a search engine; a means for receiving a plurality of search result sets, each search result set in the plurality of search result sets corresponding to one permutation search string in the plurality of permutation search strings; a means for displaying a multi-dimensional visualization of the plurality of search result sets to a user.

In an embodiment, the multi-dimensional visualization is a geometric object selected from the group consisting of: a polyhedron; a prism; an n-dimensional polytope.

In an embodiment, the geometric object comprises a plurality of cells, each one of the cells corresponding to one of the each corresponding search result sets; each axis of the geometric object corresponds to one of the plurality of knowledge domains; and the number of the cells on the each axis is equal to the quantity of the plurality of categories for the one of the plurality of knowledge domains corresponding to the each axis.

### BRIEF DESCRIPTION OF THE DRAWINGS

FIGS. 1A and 1B depict embodiments of a method and system for multi-dimensional display of search results.

FIG. 2 depicts embodiments of methods for generating a search string for use in a multi-dimensional search.

FIG. 3 depicts a conceptual schematic of a 2×2×2 cubic search result.

FIGS. 4A, 4B, 4C, 4D, 4E and 4F depict schematic diagrams of embodiments of a system according to the present disclosure.

FIG. 5 depicts a schematic diagram of an embodiment of a user interface for providing categorical data and the resulting search input after such data is translated.

FIG. 6 depicts an embodiment of permutation searches generated from user-provided categorical information in an embodiment.

FIG. 7 depicts an embodiment of a multi-dimensional visualization of search results.

FIG. 8 depicts an alternative embodiment of a multi-dimensional visualization of search results.

FIG. 9 depicts a further alternative embodiment of a multi-dimensional visualization of search results.

FIGS. 10A, 10B, and 10C depict a still further alternative embodiment of a multi-dimensional visualization of search results.

FIGS. 11A and 11B depict an alternative textual representation of permutation searches.

### DESCRIPTION OF THE PREFERRED EMBODIMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

Described herein, among other things, are systems and methods for multi-dimensional computer-aided searching. At a very high level, the systems and methods described herein use computer software to form a search input for a database or search engine based on user-provided or user-selected categorical data, and display search results in a multi-dimensional visual format, generally polyhedral, which may then be manipulated through an interactive graphical user interface to assist the user in identifying pertinent permutations.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, smart phones, tablet computers, mobile devices, server farms, hardware appliances, minicomputers, mainframe computers, video game consoles, handheld video game products, and wearable computing devices including but not limited to eyewear, wristwear, pendants, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory.

Throughout this disclosure, terms used herein to describe or reference media holding software, including without limitation terms such as “media,” “storage media,” and “memory,” may include or exclude transitory media such as signals and carrier waves.

Throughout this disclosure, the terms “web,” “web site,” “web server,” “web client,” and “web browser” refer generally to computers programmed to communicate over a network using the HyperText Transfer Protocol (“HTTP”), and/or similar and/or related protocols, including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the terms “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the term “real time” refers to software operating within operational deadlines for a given event to commence or complete, or for a given module, software, or system to respond, and generally invokes that the response or performance time is, in ordinary user perception and considered the technological context, effectively generally contemporaneous with a reference event. Those of ordinary skill in the art understand that “real time” does not literally mean the system processes input and/or responds instantaneously, but rather that the system processes and/or responds rapidly enough that the processing or response time is within the general human perception of the passage of real time in the operational context of the program. Those of ordinary skill in the art understand that, where the operational context is a graphical user interface, “real time” normally implies a response time of no more than one second of actual time, with milliseconds or microseconds being preferable. However, those of ordinary skill in the art also understand that, under other operational contexts, a system operating in “real time” may exhibit delays longer than one second, particularly where network operations are involved.

Throughout this disclosure, the terms “search engine” and “database” are generally interchangeable and refer to commercial databases, typically having a database-specific searching interface and/or searching language (e.g., set of commands or connectors that can be used to instruct the search engine on what the user is searching for). This searching interface is often a web-based interface over which the user can provide search instructions or search input. This will be understood by a person of ordinary skill to be distinct from a generic database or database management system (such as Oracle® or MySQL), though a database management system may be used to implement a “database” as that term is used herein. Examples of “database” and “search engine” as used herein include Google, LexisNexis, Westlaw, PubMed, PubMed Commons, World 1^{st}, MEDLINE, and the like.

Throughout this disclosure, the term “knowledge domain” refers to search dimensions of a topic. Conceptually, a knowledge domain can be thought of as a subtopic within a general topic or metatopic, and may itself comprise categories. By way of example, under the topic Amelia Earhart, one might identify knowledge domains such as childhood, education, flying experience, and 1928 Trans-Atlantic flight.

Throughout this disclosure, the term “permutation” generally means permutations and/or combinations as understood in mathematics. Although one of ordinary skill may understand permutations and combinations in mathematics to be related but distinct concepts, the term “permutation” is used herein to refer to both. In particular, the order in which Boolean operands appear is generally not relevant (though it may be for certain search engines, e.g., those that award weight based on order of appearance in the search criteria), and permutation searches as described herein more closely resemble the mathematical concept of combinations. For sake of simplicity and clarity, and to avoid confusion with the colloquial meaning of the term “combination” and its derivatives, the term “permutation” is used herein to mean both mathematical concepts.

At a very high level, the systems and methods described herein essentially comprise a sophisticated form of middleware connecting a user to a search engine and performing formatting operations on both search input and output in a functionally related manner. As described in more detail herein, user-provided search input is used to generate a plurality of search string permutations P_{1 . . . n}, as described elsewhere herein, which are then supplied to a third party database/search engine to receive corresponding sets of search results R_{1 . . . n}, which results are then ordered into a knowledge object which can be rendered as a visualization, generally polyhedral (though not necessarily so).

For example, in an embodiment, the formatting comprises the insertion of multi-functional Boolean operators. Search input strings are constructed from categorical information supplied by the user, and search results are displayed in a multi-dimensional visualization in which the dimensions correspond to the user-supplied categorical search criteria. The displayed visualization allows the user to quickly pinpoint specific intersections of categories which are of the most interest to the user. There is thus a functional relationship between the user-supplied categorical information and the resulting display.

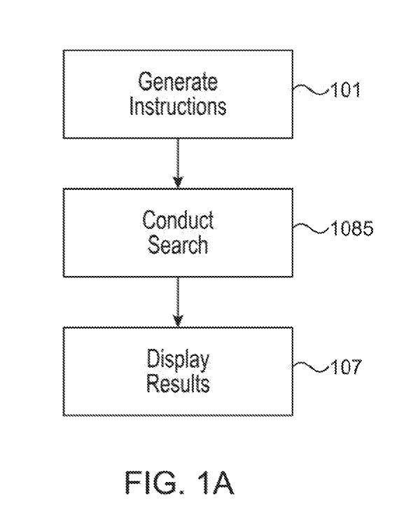

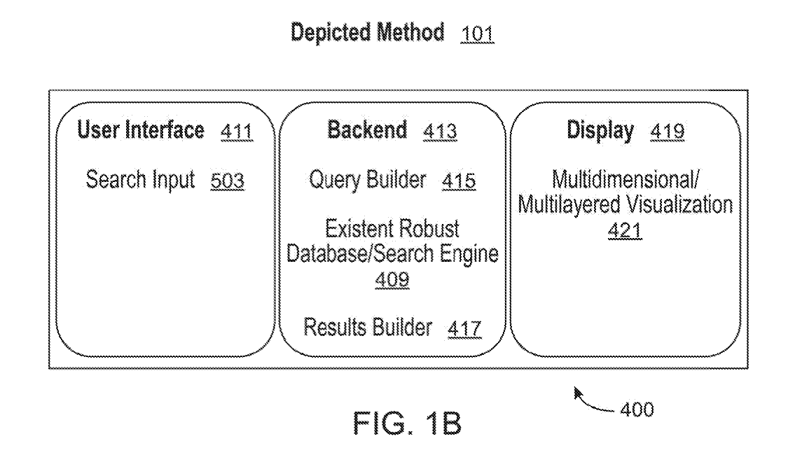

FIG. 1A depicts an embodiment (101) of a method (101) according to the present disclosure. The depicted method (101) essentially comprises three major components: generate multi-dimensional search instructions (103); conduct a search using said generated multi-dimensional search instructions (105); and display the results of said conducted search using a rendered multi-dimensional visualization (107), generally polyhedral. Each of these steps is described in further detail elsewhere herein.

FIG. 1B depicts a logical abstraction of an embodiment of a system (400) according to the present disclosure. The depicted system (400) is logically structured into three component systems: a user interface system (411), a backend system (413), and a display system (419). The depicted user interface system (411) comprises a user interface (“UI”) configured to accept or receive from a user one or more search inputs (503). The depicted backend system (413) comprises three component subsystems: a query builder module (415), a third party database/search engine (409), and a results builder module (417). Finally, the depicted display system (419) comprises a software module configured to display multi-dimensional and/or multi-layered visualization of search results (421).

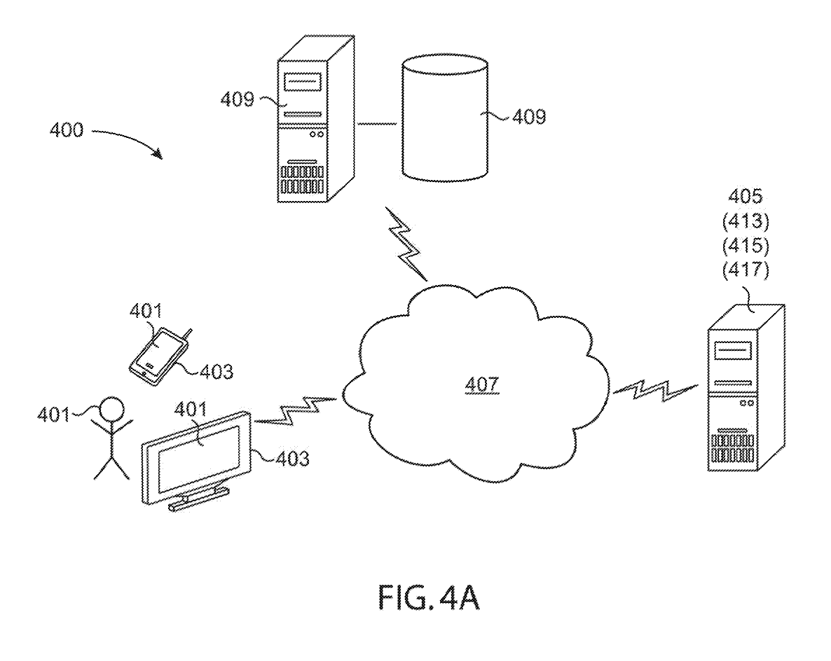

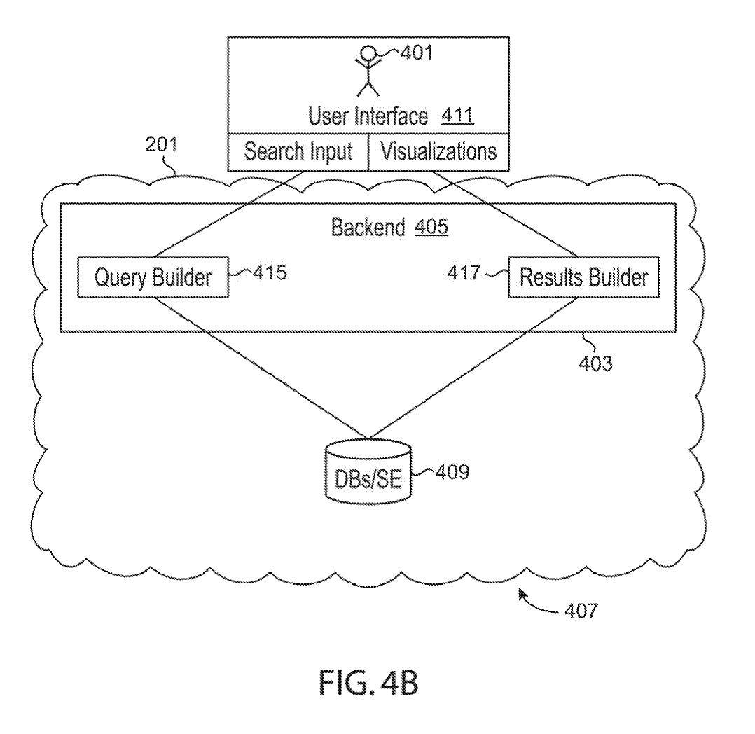

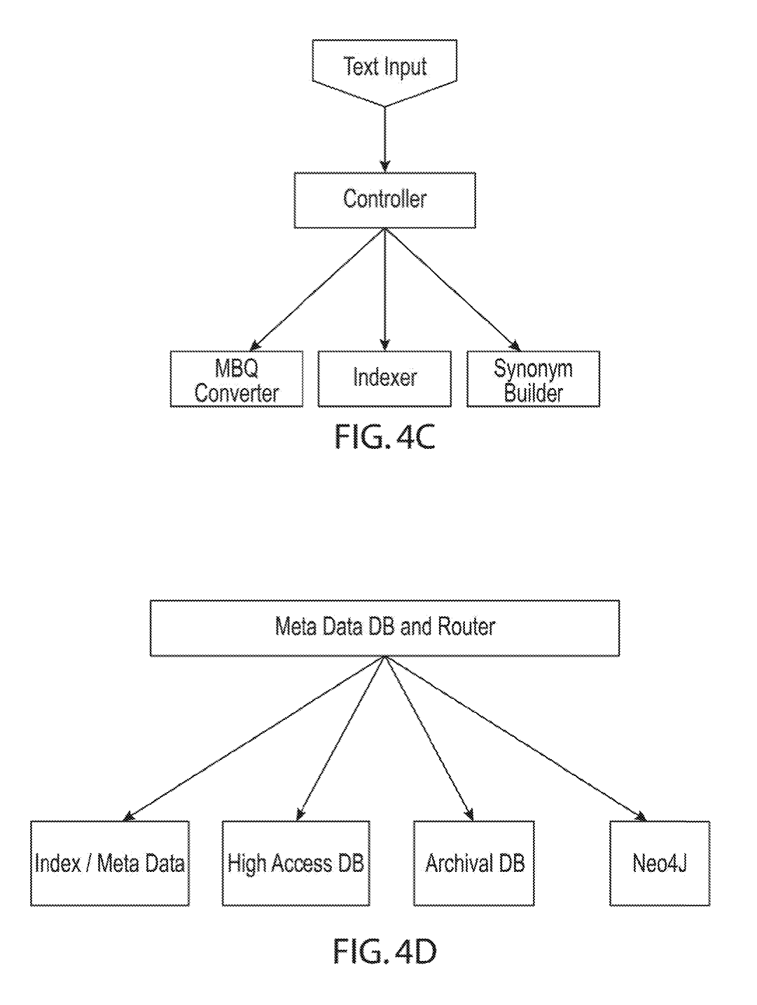

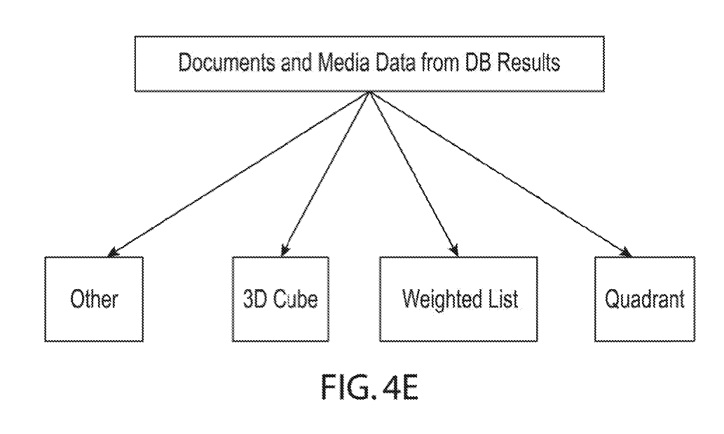

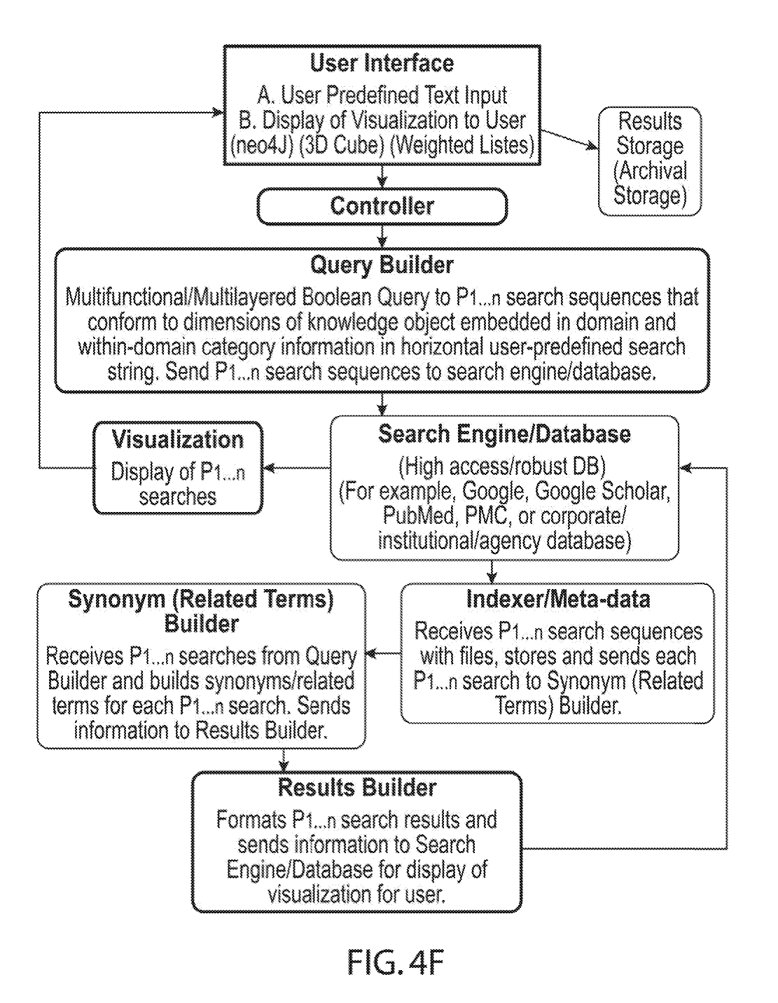

In the depicted embodiment of FIG. 1B, the query builder module (415) is configured to perform step (103), the third party database (409) is used to perform step (105), and the results builder (417) is configured to perform step (107). However, in an alternative embodiment, the division of these tasks may be different, or may be further divided and shared among various components. By way of example and not limitation, step (107), display, may use both the backend system (413) via the results builder module (417) to generate a data object representative of the multi-dimensional search results, but the software configured to display a visualization of the data, and facilitate user viewing and manipulation of the visualization and data, may be implemented via another system, such as a user device (403) associated with the user interface system (411). The logical abstraction depicted in FIG. 1B may be better understood with reference to the physical schematic depicted in FIG. 4, which is described in more detail elsewhere herein.

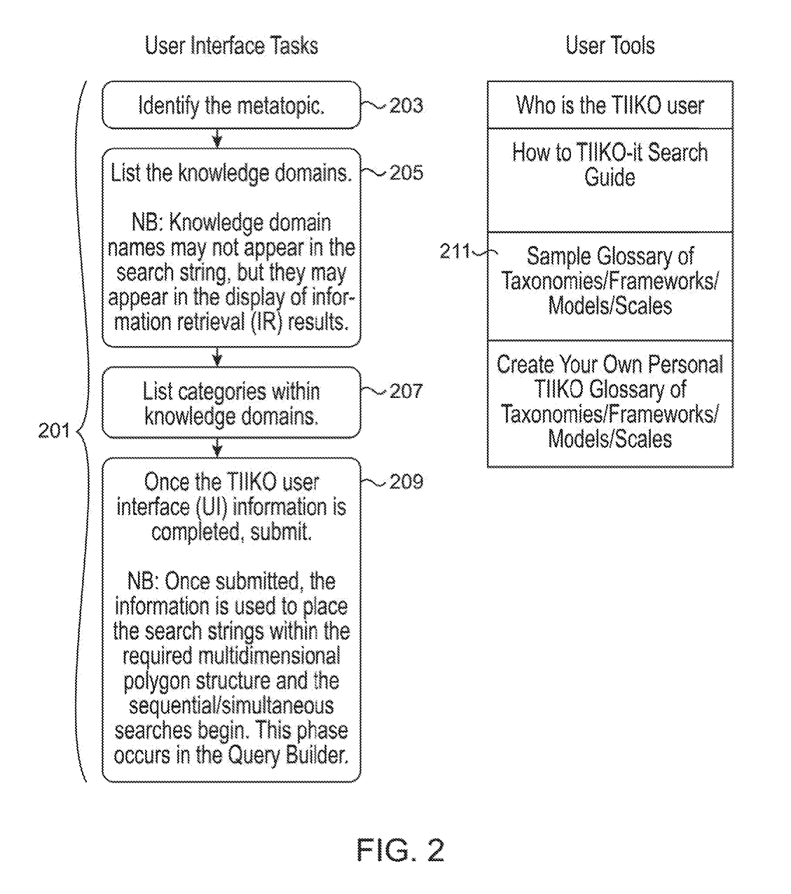

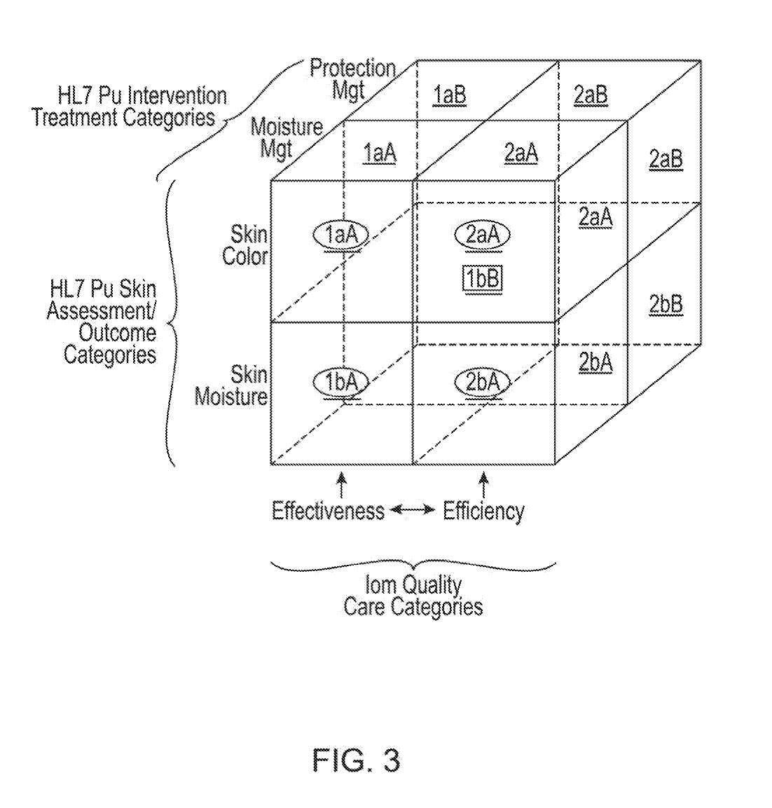

The following disclosure is made with reference to the depicted method of FIG. 2 and the depicted systems (400) of FIG. 1B and FIG. 4. The first step (101), generating search input or instructions (101), generally comprises a user (401) providing or selecting categorical search criteria (201) pertaining to the information or results sought. This data (201) is generally provided by the user (401) to a user device (403) through a user interface (411). Generally, the user device (403) is a computer, typically a desktop, laptop, tablet, mobile, or wearable device, which provides the interface (411) to the user.

The interface (411) is typically a graphical user interface, but may also or alternatively comprise non-graphical elements, including but not necessarily limited to audio interface elements such as voice recognition, personal assistant functions, and audible or spoken responses. The user interface system may be configured to structure user-supplied search input comprising search terms and multi-functional Boolean operators. Alternatively, the user interface system (411) may be configured to transfer user-supplied data received via the interface (411) to a backend system (413), where a module structures the search input as described herein. In the depicted embodiment, a query builder module (415) is specifically configured to perform that function via appropriate programming. As seen in FIG. 4, the query builder module (415) and other backend system (413) functions are preferably implemented via a remote server (405). Thus, the query builder (415) receives the user-supplied input entered via a user interface (411) of a user device (403) via a client-server communication exchange (such as, but not necessarily limited to, via a web site), as is known in the art.

The particular content of the user interface (411) will vary from embodiment to embodiment, and will change over time in response to changes in user interface technologies, design aesthetics, and user preferences. In the depicted embodiment, the user interface (411) is generally described as a web site, as user agents for web sites are almost universally available on all user devices (403). However, the user interface (411) may also be a device- or operating system-specific application (e.g., an iPhone® application) or a standalone desktop application.

The categorical search criteria (201) are generally transmitted or otherwise made available to a backend server computer (405), generally over a telecommunications network (407), such as a local network, intranet, or internet. The use of the Internet (407) as the telecommunication network (407) is generally contemplated, as Internet (407) access is almost universally available on all user devices (403). The server (405) also generally receives an indication of a third party search engine (409) or database (409) with which the search criteria (201) should be used.

The backend system (413) and (405) is generally configured to format the received search criteria (201) into one or more search inputs (503), or search strings for use with a third party database (409). In the depicted embodiment, the query builder module (415) is configured to do this, resulting in P_{1 . . . n} searches to be executed via the database (409) as described elsewhere herein. For most search engines (407), the format of the search is a text string comprising search keywords and usually optional connectors, such as Boolean operators, and range indicators. However, it is specifically contemplated that some search engines (407) may have non-text search inputs, such as binary data (e.g., non-ASCII data). In such cases, the query builder (415) module again may perform this function, providing a uniform programming interface which abstracts the particular search semantics of the underlying third party engine (409), rendering the user interface (411) and programming interface into the systems and methods agnostic as to the particular requirements of the underlying database or databases (409).

The server (405) then generally runs or causes to be run one or more searches (105) using the search engine (409) and one or more of the generated search inputs P_{1 . . . n} (503) for the search engine (409). The server (405) generally runs the search by communicating with the search engine (409) over the telecommunication network (407). This may be done via an independent module, but is preferably done via the same software module that constructs the queries, as such module necessarily has some knowledge of the input structure required by the particular database (409). In the depicted embodiment, this module is a query builder module (415).

Similarly, the search results R_{1 . . . n} are generally received by the server (405) from the search engine (409) using the telecommunication network (407). The search results R_{1 . . . n} are then organized into a multi-dimensional data object configured for visualization or display (107) by a display system (419) as described elsewhere herein. In the depicted embodiment, this step (107) is performed by a results builder (417) software module configured for that purpose via programming.

It should be noted that the user-supplied (or user-selected) categorical data may further comprise labeling data. These labels might not be directly used to generate the database-specific search input (503), and might not be otherwise supplied or provided to the search engine (409). Rather, they are generally used as descriptors (e.g., in a results builder module) in connection with the resulting multi-dimensional display (107) as described elsewhere herein. By way of example and not limitation, such labeling data may include domain labels.

FIG. 4B combines the logical schematic of FIG. 1B and the physical schematic of FIG. 4A. In the embodiment depicted in FIG. 4B, the flow of data in the system is clearly seen. Beginning with a user (401), user-supplied search input (201) is supplied via a client device (403) having a user interface (411), and is transmitted to a backend system (413) of a server (405). The backend system (413) comprises a query builder module (415) and a results builder (417) module. The query builder module (415) forms the various search queries P_{1 . . . n} as described elsewhere herein and executes those P_{1 . . . n} queries via the third party database/search engine (409). The corresponding results P_{1 . . . n} search results are received and processed by the results builder (417) into a knowledge data object, which may then be returned to the user device (403) to be displayed as a visualization, generally multi-dimensional.

FIG. 4C depicts a more detailed schematic diagram of the component modules of an embodiment of a query builder module (415). FIG. 4D depicts a more detailed schematic diagram of a typical implementation of a third party database/search engine (409). FIG. 4E depicts a more detailed schematic diagram of the component modules of an embodiment of a results builder module (419). FIG. 4F depicts a more detailed schematic diagram of how the individual subcomponents relate to each other, including the query builder module (415), results builder module (417), third party search engine/database (409), user device (403) interface and results/archival storage. In the depicted embodiment of FIG. 4F, a query builder receives user input and generates a master query and permutation queries as described herein, and executes those queries via a search engine/database. The search engine/database provides search results, which are then visualized to the user as described elsewhere herein. Alternatively, program flow in the backend may use an indexer/meta-data module, which may be configured to store/index received queries and results, and retain data or information about such queries, such as, but not necessarily limited to, metrics as described elsewhere herein. The depicted indexer module may additionally forward or share query results from the search engine with a synonym builder module. Alternativley, the synonym builder may receive search terms from the user, and provide synonyms to be included in the generated master search or permutation searches (prior to such searches being provided to the search engine for execution and retrieval of results). The synonym builder may further be configured to convert a single term or set of terms into a search clause that is functionally equivalent to a single category. By way of example and not limitation, synonyms may be separated by ORs. However, ORs in this circumstance would be included within a logical separator, such as parenthesis, to distinguish from multi-functional Boolean operators as described elsewhere herein.

The backend system (413) is generally implemented via the server computer (405), and generally contains the structure (e.g., programming) to carry out the tasks described herein, chiefly, but not exclusively, the query builder (413) and results builder (417). However, in an embodiment, certain tasks might be performed by other computing elements. For example, generating the search string (503) could be performed by software on the user device (403). Additionally, in an embodiment, there may be a plurality of servers (405) sharing the workload of generating, identifying labeling and sequencing search strings (503) to query databases (409), retrieve and display multi-dimensional results (107), and perform other administration tasks (e.g., user credentialing and authentication). The particular topology of the system (400) in a particular embodiment will depend on, among other things, the number of transactions, the power of the specific computing hardware uses, the available bandwidth, the type of user devices supported, and the databases supported.

FIG. 2 depicts an embodiment of a method for providing categorical information (201) and translating them (249) into search criteria (503). In the depicted embodiment, the categorical data (201) is generally organized into a hierarchy comprising a metatopic (203), the metatopic (203) having one or more knowledge domains (205), and each of the knowledge domains (205) having one or more categories (207). This data (201) is generally determined by the user and supplied to the user interface (411).

The metatopic (203) represents the topical focus of the search, and generally comprises terms pertinent to the overall theme of the search. Where two or more terms are required to define the metatopic (203), the terms are generally enclosed in quotation marks, or otherwise associated using other techniques known in the art. For example, “pressure ulcer prevention,” “domestic cats,” “start-up success,” or “enforcing child support.” In an embodiment, synonyms for the metatopic (203) may be programmed or configured as described elsewhere herein, generally via a query builder module (413) or synonym builder module, such as that depicted in, for example, FIGS. 4B, 4C, and/or 4F.

As defined elsewhere herein, a knowledge domain (205) is essentially a dimension of a metatopic. Such a dimension may be selected from taxonomies, theoretical frameworks, models or scales. The knowledge domains (205) are generally user-developed, or may be selected from a pre-established set or glossary of terms. As stated, and by way of example and not limitation, the pre-established set may be a glossary of taxonomies, theoretical frameworks, models, or scales. It should be noted that the identities of the knowledge domains (205) are not necessarily directly used by the search engine (409), but do contribute to the display (107) of the results as described elsewhere herein. The user (401) generally supplies an identification of each knowledge domain (205).

The categories (207) within a knowledge domain (205) are essentially particular facets or aspects or divisions of the knowledge domain (205) which may be of interest to the user (401). Because of the multi-layering functions of the Boolean operators, these facets represent not only different “aspects” of knowledge but, more literally, (1) information of sequencing of P_{1 . . . n} searches, and (2) “lines” of thought or vectors that inform the multi-dimensional visualization of results with its permutations. For example, in an embodiment comprising a query builder, the query builder is configured to structure the search query for use with the third party search engine, including ordering and sequencing of P_{1 . . . n} searches, based upon the categories (207). Similarly, the categories (207) may be used by a results builder module to structure and render a multi-dimensional visualization of the search results with its permutations.

As described elsewhere herein, each of the categories (207) may interact with each of the other categories (207) to produce different P_{1 . . . n} search results, which may be accessible through the multi-dimensional display (107). This not only helps the user (401) quickly identify which permutations resulted in a significant number of “hits” (and thus which permutations may be of interest), but also allows the user (401) to quickly navigate from one permutation to another without losing the prior permutation's result set. The user (401) may also provide a name or identifier for a category (207), if desired; or, the user may simply accept default names assigned automatically via software. Such default names are generally based upon the hyperlink to the search within each permutation.

The user-provided categorical information (i.e., metatopic, knowledge domain(s), categories) (201) is programmatically (209) translated into P_{1 . . . n} search inputs (503) for the particular search engine (409) conducting the search. However, the user interface is generally agnostic towards the requirements of the underlying search engine. Thus, the backend may be configured to programmatically adapt the search input to align with the requirements and/or restrictions of one or more search engines (409). Thus, in certain embodiments, a different search input (503) may be generated for each search engine, and, likewise, retrieval may vary in quantity and quality depending upon the feature set and capabilities of each search engine used.

It is anticipated that as search engines mature, those search engines currently lacking in feature set or robustness will become more compatible with the multi-dimensional search techniques described herein, as well as other natural language search technology. For example, some current search engines do not support an unlimited number of Boolean operators, but rather consider only the first two.

In a depicted embodiment, the backend comprises programming configured to receive the results retrieved from the permutation searches, and structure such results into a data object, referred to herein, as knowledge object, having a pre-defined structure or format suitable for use by a visualization program to create the multi-dimensional visualizations described herein. In an embodiment, a results builder module is so configured. The knowledge object may be metatopic-focused knowledge object, consisting of knowledge domains (205) and their respective categories (207).

In an embodiment, retrieval is conducted via a query builder module, and display is conducted via a results builder module. This allows search results to be organized and presented (107) as a metatopic-related body of knowledge. The user input (201), and resulting search string or strings P_{1 . . . n} (503), contain the corresponding data needed to accomplish this information retrieval, distribution, and display of P_{1 . . . n} searches.

Because the user (401) provides the metatopic (203), knowledge domains (205), and categories (207), which are then used (e.g., by a query builder module and/or server (405)) to generate and/or retrieve, the search strings, the user (401) does not necessarily have to understand how to construct search engine-specific search inputs (503). An algorithm may construct such inputs (503) using the user-provided information (201) described above. In this fashion, search engine-independent inputs (201) can be used to generate search engine-dependent search input (503), allowing users (401) to become proficient in searching multiple databases (409) using one interface (411). Thus, regardless of which database (409) will ultimately be searched, the user (401) need only become proficient with a single search interface (411). The server (405) will generally form the search input (503) based on the format required for the particular database (409) being searched. By way of example, and not limitation, where the search engine (409) to be utilized is Google®, the resulting search inputs (503) will be a text string optimized and customized for use in a Google® search. However, if the database (409) is a legal database, such as Westlaw® or Lexis Nexis®, the search input (503) will be optimized and customized for those specific search engines (409). Again, the user (401) need not understand how the specific databases operate (409), but rather only how to use the user interface (411) to supply the metatopic/knowledge domain/category information search described herein to conduct a multi-dimensional search.

The particular translation (209) steps will depend on the selected database (409) and vary from embodiment to embodiment. The following disclosure is made with reference to a typical exemplary embodiment for a search engine (409) whose search interface uses plain-text key words connected with/or allowing for Boolean operators. It will be understood by one of ordinary skill in the art that other connectors are also possible, such as distance and range connectors (e.g., Term A appears in the searched documents within n words of Term B). It will further be understood by one of ordinary skill in the art that unary operators may be used (e.g., NOT, or AT LEAST operators).

It should be recalled that in conducting the search, the user (401) is not necessarily searching for results that match all terms, but rather seeking an overall body of knowledge using combinations of terms expected to provide useful or relevant results. That is, the user (401) provides a number of categories (207) within knowledge domains (203), but the user (401) may not care whether every category (207) within a given knowledge domain (205) appears in the search results. Rather, the user (401), by providing the categories (207), has indicated what facets or aspects or divisions of the knowledge domain (205) the user (401) is interested in. As such, any search result including at least one category (207) from the knowledge domain (205) may be relevant. Relevancy is generally a subject measure within the perception of the user. Thus, the relevancy of a search result depends on whether, in the user's judgment, the result is of value to the user or meets the user's needs. While limited search results within one or more categories may be valuable, generally, a higher number and/or rate of desired search results is more likely to meet user needs than a lower number and/or rate. However, while recognizing that a greater rate of desired results is typically better than few search results reflective of one category, the smaller number of results may still be important to the the user in conducting the search.

The user (401) generally seeks search results that match at least one category within at least one knowledge domain, and, more generally, at least one category within at least two knowledge domains. The user (401) may not need results that match all categories within any one knowledge domain or, in the more complex polyhedral displays/visualizations, from within all knowledge domains.

Thus, in an embodiment, the search input (503) is structured to return results under this searching strategy using grouping operators and Boolean operators. Stated simply, a search string (503) is formed (209) comprising one set of grouped search criteria for each knowledge domain (205) joined by AND operators, with each such set of grouped search criteria comprising the set of categories (207) for the corresponding knowledge domain (205) joined by OR operators. This overall search is then joined with the metatopic (203) by an AND operator. Individual search permutations are generally also run for each combination of categories. An illustrative example may provide further clarity.

Further, the user may want to see the full display and manage which searches to discount. Thus, the above embodiment may be further refined such that synonyms using OR are distinguished from within-domain category ORs by special denotation in the user interface. As discussed elsewhere herein, organization operations may be interrupted and performed by a query builder module for P_{1 . . . n} searches, and in a results builder module for P_{1 . . . n} visualizations within the knowledge object.

Additionally, in an embodiment, the search input (503) is structured to return results under this searching strategy using grouping operators (e.g., synonyms via a synonym builder module) and multi-layered Boolean operators (e.g., in a query builder and/or synonym builder module). This overall search is joined with the metatopic (203) by a multi-layered AND operator. Stated simply, a search string (503) is then formed (209) comprising one set of grouped search criteria for each knowledge domain (205) joined by AND operators, with the number of AND operators connecting knowledge domains representing the number of faces/sides of the multi-dimensional display of results. Within each such set of grouped search criteria comprising the set of categories (207) for the corresponding knowledge domain (205) joined by multi-layered OR operators, with the number of OR operators indicating the number of categories (number of ‘lines’ of thought or vectors) within each grouped set or knowledge domain, individual search permutations are generally run for each combination of categories, or within-domain category. The creation of these permutations deconstructs in a mathematically organized manner what might appear to be an extended faceted information search strung together by Boolean operators. The multi-layered functionality of the Boolean operators, however, allow for the creation of dimensions and vectors within dimensions and the deconstruction of the overall search into its logical subsections/cells.

In an embodiment using grouping (i.e., synonyms), the search string (503) is formed (209) comprising a set or sets of grouped search criteria. In such an embodiment, grouped search criteria within a knowledge domain represent one category or division of the knowledge domain (205). Grouped search sections, representing one knowledge domain, may be joined to other grouped search criteria (a second knowledge domain) by Boolean ORs, with the total number of ORs in any one group indicative of the total number of categories within that particular knowledge domain. The knowledge domains may then be connected to a second (or third, etc.) knowledge domain by Boolean ANDs. The total number of ANDs joining the metatopic to each of the knowledge domains within the search string then constitutes the total number of dimensions of the knowledge object that will be constructed from the search results (e.g., a construction with three search dimensions is a visualization with three display dimensions, such as a rectangular prism or cube). However, the decision rules for varying visualizations may change, as for example, when the total number of ANDs connecting knowledge domains in a search string is five, then the visualization may be that of a pentagon, with each AND representing each of five pentagon's five sides and, the total number of non-grouped ORs represent the number of floors. In other words, the simple counting of Boolean ANDs and ORs may be used to determine the shape and size of the knowledge object. In this fashion, the structure and/or content of the generated master and/or permutation queries itself can be used to programmatically determine the shape of the resulting visualization. Alternatively, this decision may be left up to a visualization module and/or user input or preferences. The creation of permutations as described above also deconstructs, in a mathematically organized manner, what might otherwise appear to be an extended, categorical information search strung together by Boolean operators. That is, the multi-functionality of the Boolean operators allows for the creation of dimensions outlining the shape of a knowledge object, categories within knowledge domains, and divisions (cells or permutations) within categories. This in turn allows for the deconstruction of the overall master search into its logical subsections/cells.

In a preferred embodiment, the Boolean operators are multi-layered, meaning one set of Boolean operators is used within a grouping, and a plurality of such grouping is joined using a second set of Boolean operators. As explained in more detail throughout this disclosure, the numbers of AND or OR Boolean operators, respectively, count anything, for example the number of knowledge domains, categories within domains; or, they may be used to identity cell boundaries or domain categories; or, they may be used to count the dimensions of an object. Because varied polygonal knowledge objects require varied ways in which Boolean operators are used, suffice it to say that a programming method used for creating each polygonal shape is standardized within the backend query builder and results builder; and that this standardized information is fed into the user interface to create the knowledge object shaped in accord with user input. There is a complicating feature: some OR connectors are used for the sole purpose of connecting synonyms; these are not used for counting purposes. Within the backend, this issue is managed within the Synonym Builder, as described elsewhere (FIG. 4C).

In an embodiment, the Boolean operators are multi-layered, meaning that they serve as operands even as they also serve as AND connectors between dimensions/domains and serve as OR connectors between within domain categories and serve as ORs connecting synonyms within grouped categories. As also explained in more detail throughout this disclosure, the number of AND and OR Boolean operators are indicators of the number of domains and within domain categories, respectively; and, because the number of Boolean operators simply represent numbers, those numbers may to used to count anything, for example the number of knowledge domains, categories within domains; or, they may be used to demarcate divisions or cell boundaries within domain categories; or, they may be used to count the dimensions of an object, the number of its sides/floors, faces, vectors, or vertices. Because varied polygonal knowledge objects require varied ways in which Boolean operators are used, suffice it to say that a programming method used for creating each polygonal shape is standardized within the backend query builder and results builder; and that this standardized information is fed into the user interface to create the knowledge object shaped in accord with user input. There is a complicating feature: some OR connectors are used for the sole purpose of connecting synonyms; these are not used for counting purposes. Within the backend, this issue is managed within the Synonym Builder, as described elsewhere (FIG. 4C).

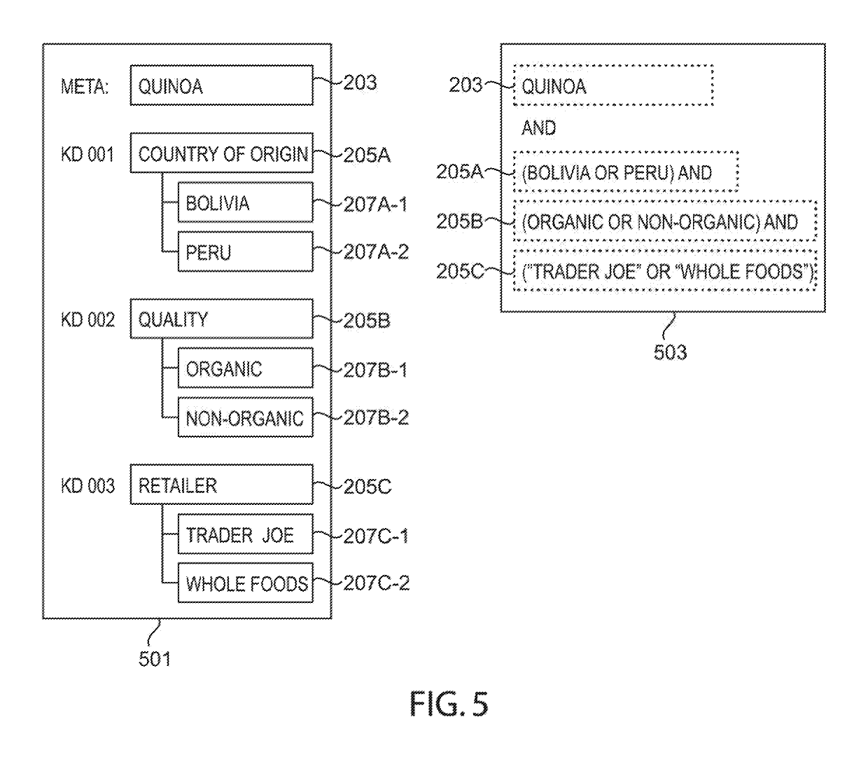

FIG. 5 depicts an illustrative example of forming a search query (503), where the user (401) is searching for information about the quinoa grain. The illustrative embodiment depicted in FIG. 5 includes a user interface (501) for inputting the categorical information (201). In the depicted embodiment, the metatopic (203) for the search is “quinoa,” as any relevant search result is likely to include this term, and so the user (401) has provided the term “quinoa” into the metatopic (203) input element. Although a text input box is depicted in FIG. 5, as described elsewhere herein, other forms and means of inputting search criteria (201) are possible, including non-textual input elements such as speech to text. The user (401) in this example has also selected three knowledge domains (205A), (205B), and (205C).

In the illustrative embodiment of FIG. 5, the first knowledge domain (205A) is “country of origin” and the user (401) has provided the term “country of origin” in the first knowledge domain (205A) input element. Again, this text is not directly used to conduct the search, but may be used in the display, such as, but not necessarily limited to, as labels for the dimensions represented. The second knowledge domain (205B) is “quality” and so the user (401) has provided the term “quality” in the second knowledge domain (205B) input element. The third knowledge domain (205C) is “retailer” and so the user (401) has provided the term “retailer” in the third knowledge domain (205C) input element.

Within each knowledge domain (205A), (205B) and (205C), the user (401) has also specified one or more categories (207A), (207B) and (207C). For the first knowledge domain (205A), “country of origin,” the user (401) has provided two categories, “Bolivia” (207A-1) and “Peru” (207A-2). For the second knowledge domain (205B), “quality,” the user (401) has provided two categories, “organic” (207B-1) and “non-organic” (207B-2). For the third knowledge domain (205C), “retailer,” the user (401) has provided two categories, “Trader Joe's” (207C-1) and “Whole Foods” (207C-2).

Although three knowledge domains each having two categories is depicted, it should be noted that more (or fewer) knowledge domains may be used in an embodiment, and that a knowledge domain may have more (or fewer) categories. It should be further noted that not all knowledge domains need have the same number of categories.

Also depicted in the illustrative embodiment of FIG. 5 is a generated search input (503). The categories (207A) for the first knowledge domain (205A) are grouped in parentheses and joined by a Boolean OR operator (e.g., “BOLIVIA OR PERU”). Likewise, the categories (207B) for the second knowledge domain (205B) are grouped in parentheses and joined by a Boolean OR operator (e.g., “ORGANIC OR ‘NON-ORGANIC’”). Finally, the categories (207C) for the third knowledge domain (205C) are also grouped in parentheses and joined by a Boolean OR operator (e.g., “‘TRADER JOE'S’ OR ‘WHOLE FOODS’”). Each one of these three sets of knowledge domain (205A), (205B), (205C) categories (207A) to (207C) is then joined in the resulting search input (503) by a Boolean AND operator, as is the metatopic (203). The resulting search input (503) string is ready to be run with the search engine (409) or engines selected.

It should be noted that, in addition to, or alternatively to, the master search (503) described above, one or more permutation searches are also generally generated and run using the search engine (409). It is important to recogozine that a search string with three knowledge domains has three dimensions, which in turn correspond to the dimensionality of the generated knowledge object and, ultimately, of the visualization. As shown in illustrative examples elsewhere herein, if there are two within-domain categories within each knowledge domain, a possible resulting visualization is a 2×2×2 cube, having three dimensions with two cells or divisions within each dimension. The interaction of the dimensions and divisions result in the cells (or permuations), where a permutation is all of several of all possible variations.

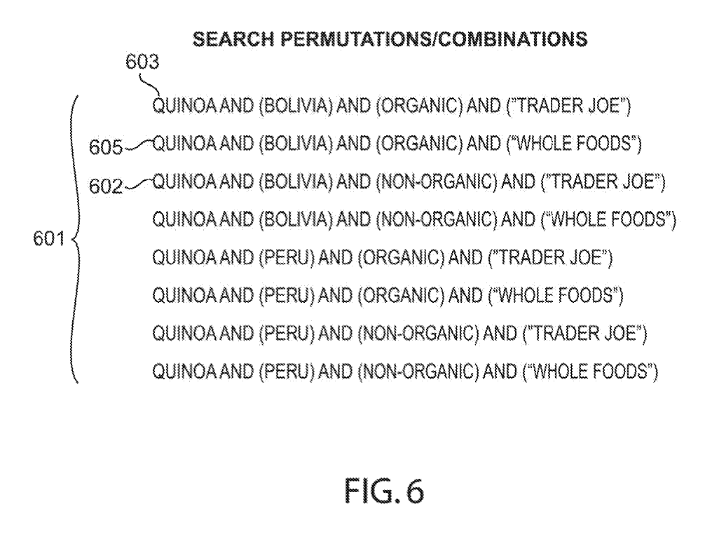

For each permutation or cell, there is a unique search string. In certain embodiments, the search string associated with one or more cells or permutations may yield zero search results. Generally, a permutation search result may be accessed as a hyperlink to a search result accessed from within a cell of a multi-dimensional visualization. This permutation/cell (or a unit block or cell/block series if so configured), when activated, yields hyperlinked search results for easy access to the unit block or cell/block search results by the user. Again, in certain embodiments, searches conducted within one or more cells/permutations may yield zero results; in a simililar manner searches conducted that encompass one or morer unit blocks may yield zero results. Continuing the illustrative embodiment of FIG. 5, FIG. 6 depicts an embodiment of the permutation searches (601) which would result from the categorical search criteria depicted in FIG. 5. Because the embodiment of FIG. 5 comprises three knowledge domains (205A), (205B), and (205C), each having two categories, if one category is used from each knowledge domain for each permutation search, eight permutation searches (601) are possible (i.e., 2×2×2=8). Each permutation search (601) essentially comprises the metatopic (203) plus a category selected from each knowledge domain, all joined by the Boolean AND operator. For example, the first permutation search (603) searches for QUINOA, BOLIVIA, ORGANIC, and TRADER JOE'S, and the second permutation search (605) searches for QUINOA, BOLIVIA, ORGANIC, and WHOLE FOODS. The other six resulting permutation searches in this illustrative example are also displayed in FIG. 6.

Each permutation search (601) will generally produce different search results, though there may be some overlap. Some permutation searches (601) may produce no results. It should be noted that in an embodiment the permutation searches (601) may be conducted simultaneously, sequentially, or in parallel with the master search (503). In an alternative embodiment, one or more permutation searches (601) may be delayed or conducted during or after display of the search visualization (107). The particular ordering of when the searches are run against the database (409) will vary from embodiment to embodiment, and within an embodiment, from third party database (409) to third party database (409), depending upon third party database capacity and policies. This is because the use policies for third party database (409) vendors may vary, and may disallow a certain number of automated searches during a given period of time. Additionally, commercially licensed databases (401) may charge a per search fee or the user (401) may have a chargeback mechanism for invoicing customers for the searches, and the user (401) may desire to delay the permutation searches, or approve them individually or as a group before they are run, to avoid incurring excessive charges.

Although FIGS. 5 and 6 depict a text-based search input (503), it will be understood that some search engines (409) may use alternative formatting. One non-limiting example is that the search engine (409) may enter “AND” or “OR” if no operator is specified, or may substitute a symbol for an operator. Another non-limiting example is that a search engine (409) may not use text-based search input (503) at all, but rather require the search criteria to be packaged into a particular pre-defined data structure. The specific format of the resulting search input (503) may vary from embodiment to embodiment, and the present disclosure is operative with any search engine (409) supporting basic Boolean operators. In an embodiment, other operators may also be included, such as to filter out results known to be irrelevant. For example, the unary NOT operator may be joined to a search input (503), whether a master search (503) or a permutation search (601), by an AND operator. For example, in the illustrative embodiments of FIGS. 5 and 6, recipes might be excluded by adding “AND NOT(RECIPE)” to the search input (503) and (601).

Once the search results are received, the server (405) causes them to be displayed to the user (401), generally on the user device (403) using a multi-dimensional visualization of the body of knowledge represented by the search results. This generally comprises generating and/or rendering a multi-dimensional object. The multi-dimensional object is typically projected or otherwise rendered on a two-dimensional display (e.g., a computer screen). Techniques for projecting three-dimensional objects on a two-dimensional display are well-known (e.g., the OpenGL library).

In a typical embodiment, the multi-dimensional object is an n-faced polyhedron (702). For example, where the user (401) provides three knowledge domains (205), as in FIGS. 5 and 6, the resulting polyhedron (702) would be a six-faced polyhedron (702)—effectively, a rectangular prism (702). While a regular polyhedron may result if each knowledge domain (205) has an equal number of categories (207), this will not always be the case, and the displayed polyhedron (702) may be irregular. Further, for sake of rendering simplicity, regular polyhedrons (702) may be avoided in favor of prisms for high-dimensionality searches, as described elsewhere herein. The dimensions (which, again, represent divisions, vectors, or lines of thought of the faces of the resulting polyhedron (702)) correspond to the number of categories (207) in each of the knowledge domains (205) (i.e., to the number of ANDs and the number of ORs used as connectors between and among knowledge domains and their respective categories). This may be better understood with reference to an example.

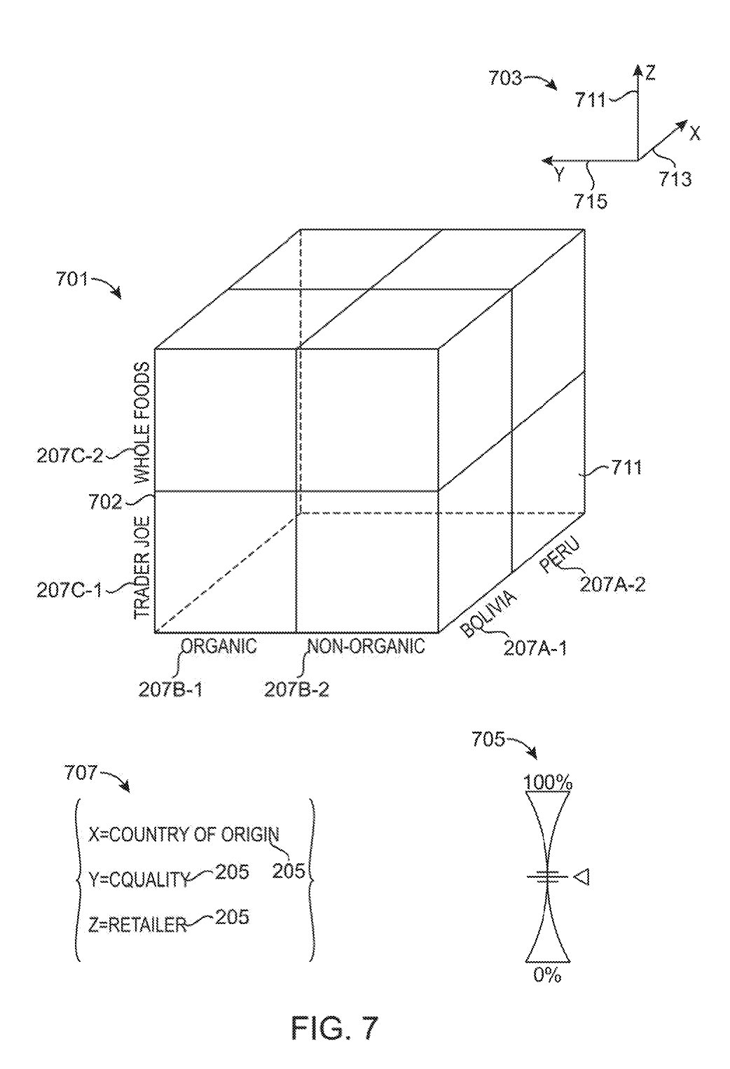

When the search concludes, but prior to the display of search results, the display portion of the algorithm may draw upon the information contained in the knowledge domain (205) names in several ways. In an embodiment, this functionality is implemented via a results builder module. If the polyhedron (702) is square or rectangular, each knowledge domain (207) may represent a different dimension (e.g., height, width, depth). Also, if the polyhedron (702) comprises three or more knowledge domains (207), each domain may represent a different side or plane of the polyhedron (207) or prism (207) being created. In the illustrative embodiment of FIG. 7, a multi-dimensional display (701) is depicted using the search criteria of FIGS. 5 and 6. In the depicted embodiment, the user (401) provided three knowledge domains (205), resulting in a six-faced polyhedron (702). Because each of the three knowledge domains (205) comprises two categories (207), the resulting polyhedron (702) is a 2×2×2 polyhedron (702), or a cube (207).

Recalling that knowledge domains (205) are dimensions of a search, the depicted display (701) comprises an axis (703) and a legend (707) showing which knowledge domain (205) is represented along which dimension of the cube (702). In the depicted embodiment, the x-axis (713) recedes into the depth of the display and corresponds to the “country of origin” (205A) knowledge domain (205). Thus, the “front” half of the cube (702) represents search permutation results that included the “Bolivia” category (207A-1) and the “back” half of the cube (702) represents search permutation results that included “Peru” (207A-2).

In the depicted embodiment, the y-axis (715) runs laterally across the display and corresponds to the “quality” (205B) knowledge domain (205). Thus, the “left” half of the cube (702) represents search permutation results that included “Organic” (207B-1) and the “right” half of the cube (702) represents search permutation results that included “Non-Organic” (207B-2). Finally, the z-axis (717) runs vertically on the display and corresponds to the “retailer” (205C) knowledge domain (205). Thus, the “top” half of the cube (702) represents search permutation results that included “Whole Foods” (207C-2) and the “bottom” half of the cube (702) represents search permutation results that included “Trader Joe's” (207C-1).

Because there are two categories in each of three knowledge domains, resulting in eight permutation searches, the resulting polyhedron (702) has eight component blocks, e.g., (709) and (711), each representing one such permutation search. Each unit block of the displayed visualization (702) represents the search results of a permutation search. The categories for the permutation search represented by a given unit block can be determined by simply examining the categories represented by the category value represented by each axis/dimension of the block. As can be seen in FIG. 7, any one block of the cube (702) is an intersection of one category from each of three knowledge domains. For example, block (709) is in the “front” half of the cube and thus represents search results including “Bolivia” (207A-1). Block (709) is also in the “right” half of the cube and thus represents search results including “Non-Organic” (207B-2). Block (709) is also in the “bottom” half of the cube and thus represents search results including “Trader Joe's” (207C-1). Taken together, the search permutation represented by block (709) is “QUINOA AND BOLIVIA AND NON-ORGANIC AND TRADER JOE's” (607).

The multi-dimensional display (701) thus can quickly and easily convey a vast amount of information to the user (401). For example, the color of as given block may correspond to the number of search hits resulting from the corresponding permutation search. This would result in the rendered polyhedron (702) serving as, effectively, a multi-dimensional heat map, where the user (401) can quickly and visually identify “hot spots” with large numbers of hits, as well as quickly locate “cold spots” with few hits. This data alone may be useful without even viewing the permutation search results for a given block. For example, if there are few or no search results for permutation search PERU AND NON-ORGANIC AND TRADER JOE'S, then block (711), corresponding to that permutation search, may be rendered in a fashion to visually convey the low response level, such as by using cool shades or low-opacity. This gives the user (401) a quick visual cue that there is little information available for non-organic Peruvian quinoa at Trader Joe's.

As alluded to elsewhere, it is important to appreciate the functional relationship between the displayed object (702) and the original search input (503). As can be seen in FIGS. 5, 6, and 7, the resulting displayed object (702) has a functional relationship to the categorical information provided by the user (401). This relationship can be seen in several respects. First, the number of knowledge domains (205) is functionally related to the appearance of the resulting polyhedron, in terms of the number of faces. (702). Second, the number of categories within each knowledge domain is also functionally related to the dimensions of the faces on the resulting polyhedron (702). Thus, the aspects of the server (405) software concerning creating and structuring the search input (503) (e.g., a query builder module) do more than merely translate one element of text input to another, but rather structure the search input (503) (both the master search and the permutation searches P_{1 . . . n}) to get results that specifically correspond to mathematical elements of the object (702), where the content of the visualization (702) is itself functionally related to the user's (401) original input parameters. In other words, if the user (401) input changes, the resulting displayed object (702) likewise changes.

The displayed visualization (702) may be manipulated by the user (401) using typical operations well-understood in the art, such as panning, zooming, rotating, and scaling. Interface (401) elements may be provided to indicate the current status of the displayed object (702). For example, axis element (703) may rotate in a manner corresponding to the rotation of the cube (702), so that the user (401) has a ready visual reference for how the cube (702) is presently oriented on screen. Similarly, a zoom level indicator (705) may be provided. In an embodiment, the cube (702) may be labeled with text indicators. These and other interface elements may be enabled or disabled in a given embodiment.

This differs from other search techniques in that the search input (503) is the product of the user (401) having selected and ordered distinct categories (207) within distinct knowledge domains (205), resulting in a highly organized and multi-dimensional search input (503) functionally corresponding to the resulting multi-dimensional search result visualization (702).

In the illustrative embodiments of FIGS. 5, 6, and 7, the number and location of the dimensions of the visualization (702) are determined by the number and location of Boolean ANDs in the search input (503). The Boolean ANDs serve several purposes. First, they serve as an operator that connects the metatopic (203) to the knowledge domains (205). Second, the number and location of the Boolean ANDs provide multi-dimensional information and other cues and commands. For example, as already indicated, when there are three Boolean ANDs within a search input (503), the resultant visualization (702) is shaped as a rectangular or square polyhedron (702) in three dimensions. It should be understood that the particular arrangement of the knowledge domains/dimensions on the polyhedron (702) is effectively arbitrary, though from a programmatic standpoint some defaults will likely be selected. For example, the first AND may signal the first dimension (e.g., width), the second AND may signal the second dimension (e.g., height), and the third AND may signal the third dimension (e.g., depth).

One of ordinary skill in the art will, of course, appreciate that user-provided search input (201) causes a server-implemented backend algorithm on the server (405) (e.g., a query builder module) to translate or distribute information into instructions (503) (e.g., via a results builder module) that are used by the search engine (409) to structure simultaneous or sequential multi-dimensional searches which yield the desired retrieval(s). The algorithm may also provide multi-dimensional, usually polyhedric, display instructions as described herein. This display reflects a body of knowledge elicited by the metatopic (203), and is composed of n knowledge domains (205) and their respective categories (207).

As described elsewhere herein, each unit block of the resulting displayed object (702) represents one permutation search result set. In an embodiment, the total number of search results may be displayed or otherwise indicated in association with the corresponding unit block.

Once the user (401) has identified, using the visualization (107) (702), a permutation the user (401) is interested in exploring further (e.g., a unit block, cell, floor, or side), the user (401) can click/touch/otherwise activate the relevant permutation in the visualization (702), and call up the list of search results associated with that permutation. Such result may be displayed in a conventional linear format, which may include the native format or appearance of the search engine (409) which produces the results. The search results may also automatically update at fixed time intervals (e.g., five or ten minutes, daily, weekly, etc.) to ensure that the user (401) is viewing the most current search results available from the search engine (401), as cached by the system. The system (400) may also or alternatively preserve a history of search results, allowing the user (401) to store the search and see how the results change over time, such as by having the search automatically re-run and update according to a defined schedule or frequency, or when manually instructed.

In an embodiment tracking search history, the visualization (702) can be saved and “played back” in an animation to show the change in search criteria and/or results over time. For example, continuing the quinoa example, the user (401) may discover over the course of a year that results for “Peru” are initially sparse but then become brighter as more and more search results are found, suggesting that “Peru” is emerging as a hot topic in the quinoa industry. Thus, the present disclosure contemplates the use of the visualization (702) as a tool to track changes over time in search results, and thus changes in the body of knowledge. This “heat map” aspect may be triggered by frequency counts, which may also be used for tracking purposes, where frequency is understood to mean the number of results in the permutation search.

In an embodiment, the user (401) may scroll through a linear list of results pertinent to each cell without leaving the display page. In this way, the user (401) need not fully disengage from the categorical reasoning undergirding the display (702). More particularly, because the user (401) may explore related knowledge domain (205) categories (207) and even knowledge domains (205) at will, the user (401) remains cognizant that any one area of interest (cell or row or column or even planar surface) represents just a part of the body of knowledge under study. Such cognizance or insight facilitates the speed with which content within a body of knowledge is grasped, learned, and expressed, verbally or in writing.

While the systems and methods have generally been described with respect to cubic or rectangular prism (702) results, an important aspect of the invention is the ability to model multi-dimensional search results, which have a number of dimensions beyond that of ordinary human perception. As described, a four or five or n-dimension search result may be possible. That is, arbitrary dimensioned objects (902) are simple to model in mathematics, and therefore simple to model in computer science. It is an elementary construct in even low-level languages to define a multi-dimensional array where the number of dimensions exceeds the number perceptible by or via ordinary human senses. This means that the user (401) may provide four or more knowledge domains (205), each of which may consist of an arbitrary number of categories (207), which can be modeled in the search result programmatically, because the computer algorithm is fundamentally based upon mathematics, and arbitrary dimensional objects may be modeled mathematically.

This mathematical simplicity is difficult to model in display. Even with three dimensional objects, such as a cubic (702) result set, a three-dimensional object (702) is projected onto a two-dimensional surface (the computer monitor or mobile device screen). Modeling an object with more than three dimensions on a screen with only two dimensions is even more difficult. However, in an embodiment, up to three knowledge domains (205) (surfaces) may be modeled together in a displayed polyhedron (702). The other, undisplayed, knowledge domains (potential surfaces) may be listed or otherwise indicated on the screen, and the user interface allows the user (401) to drag and drop or otherwise swap one surface in the displayed cube (702) with one of the undisplayed surfaces. This may then cause the resulting search set to be rerun for the simultaneous/sequential searches (601). Furthermore, the use of immersion experiences in virtual art opens like expressions within multi-dimensional knowledge objects.

In an embodiment, the visualization may comprise the use of augmented reality features and/or augment teaching/learning methodologies, not only in the study of information retrieval methods and applications, but in studying categorical reasoning, analysis, academic/scientific writing, cognition, especially cognition speed and comprehension.

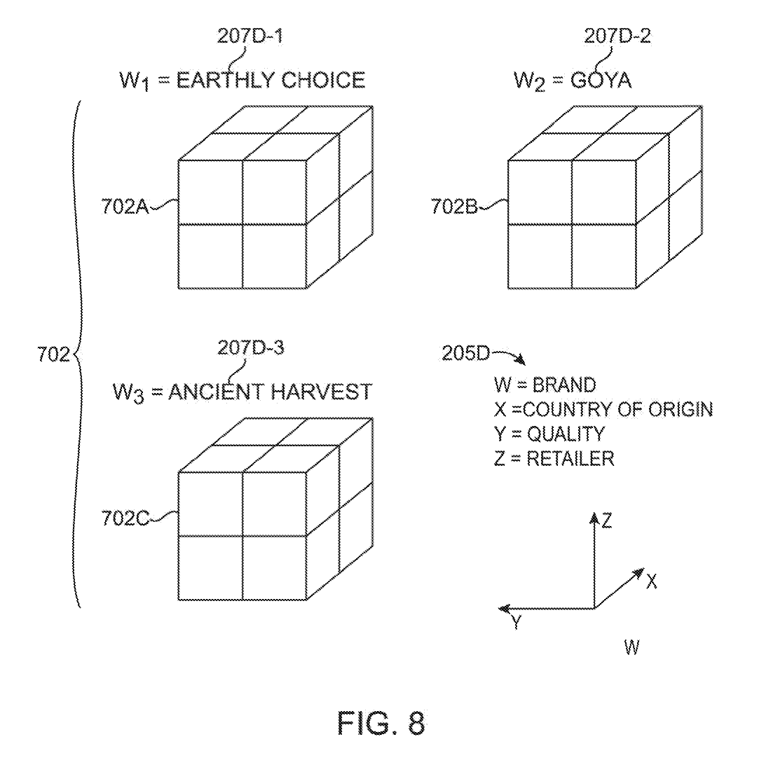

While a rectangular prism (702) is an efficient visualization to organize a three-dimensional search (e.g., three knowledge domains), higher-order searches may require more complex visualizations. For example, in the illustrative embodiment of FIG. 8, which continues the illustrative embodiments of FIGS. 5, 6, and 7, the user (401) has added a fourth knowledge domain (i.e., dimension), “brand” (205D), having three categories (“earthly choice” (207D-1), “goya” (207D-2), and “ancient harvest” (207D-3)). In the depicted embodiment of FIG. 8, the fourth dimension is rendered visually by displaying an array of three-dimensional objects (702D), (702B) and (702C), with each one representing one unit block of the fourth dimension (or knowledge domain). For example, depicted cube (702A) represents the first unit block, “earthly choice” (207D-1), or the fourth dimension, “brand” (205D). Thus, the eight individual unit blocks of cube (702A) each represent the eight permutation searches (601) depicted in FIGS. 6 and 7, with the additional permutation of “earthly choice” (i.e., the permutation searches depicted in FIG. 6, each of which is also ANDed with “earthly choice”). Similarly, depicted cube (702B) represents the second unit block, corresponding to the second category (“goya”) of the fourth dimension (“brand”), and its contents represent the search results of the eight permutation searches depicted in FIG. 6 when ANDed with “goya”. Finally, depicted cube (702C) represents the third unit block, corresponding to the third category (“ancient harvest”) of the fourth dimension (“brand”), and its contents represent the search results of the eight permutation searches depicted in FIG. 6 when ANDed with “ancient harvest”.

In such an embodiment, the efficiency of the visualization (702) may be impacted by the particular size of each dimension. For example, if the “brand” dimension (205D) has dozens of categories (as opposed to the three depicted), then dozens of cubes (702) would be displayed to visually represent the fourth dimension. However, since other dimensions in this exemplary embodiment have only two categories (e.g., “country of origin”), it may be more efficient to display only two cubes (702), using “country of origin” as the fourth dimension, with each cube (702) having one longer dimension (“brand”) with more categories. In an embodiment, the user interface (411) includes an option for the user (401) to instruct the server (405) to automatically determine how to arrange the dimensions to maximize or otherwise improve the efficiency of screen space utilization. In another embodiment, the user interface (411) includes interface components operable to allow the user (401) to indicate how the user (401) would like the dimensions arranged, causing the visualization (707) to then update with the user-provided configuration options.

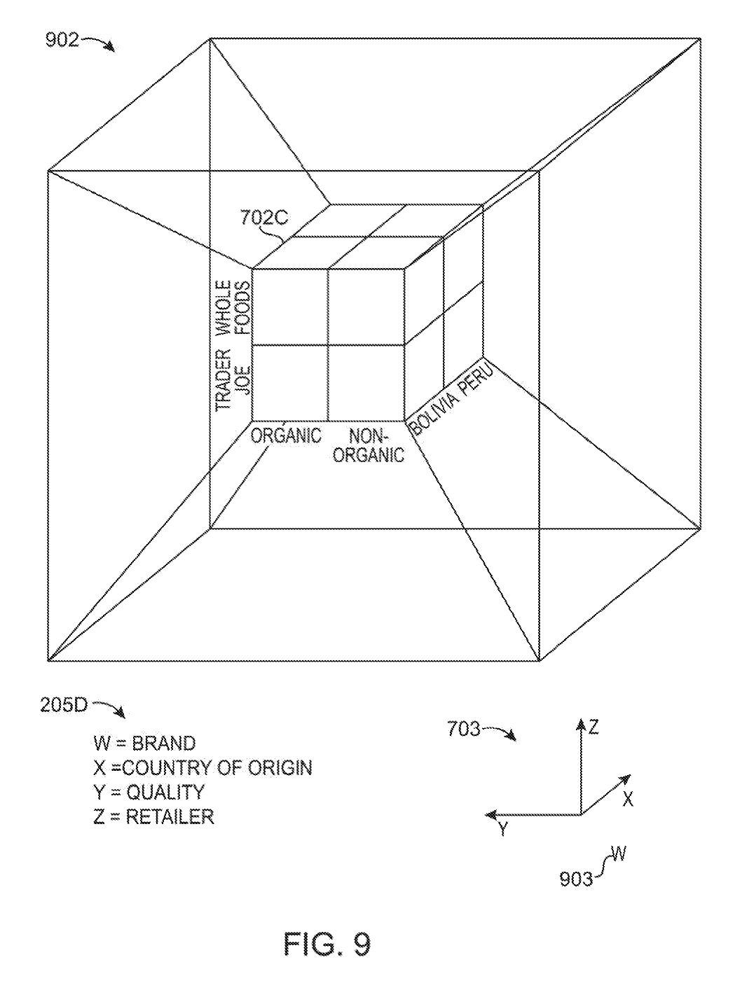

In an alternative embodiment, a four-dimensional object (702) may be visually depicted as a hypercube (902) or tesseract (902). One such illustrative embodiment is depicted in FIG. 9, where the w dimension (901) is the projection of the cube (702) into four-dimensional space. As with the other illustrative examples, the same user manipulation operations are supported, with the addition of user controls operable for four-dimensional rotations (e.g., along the xw, yz, and zw axis). Such techniques may also be used for visualization (702) and (902) of an arbitrary n-dimension object, such as n-cubes, penteracts, hexeracts, and so forth.

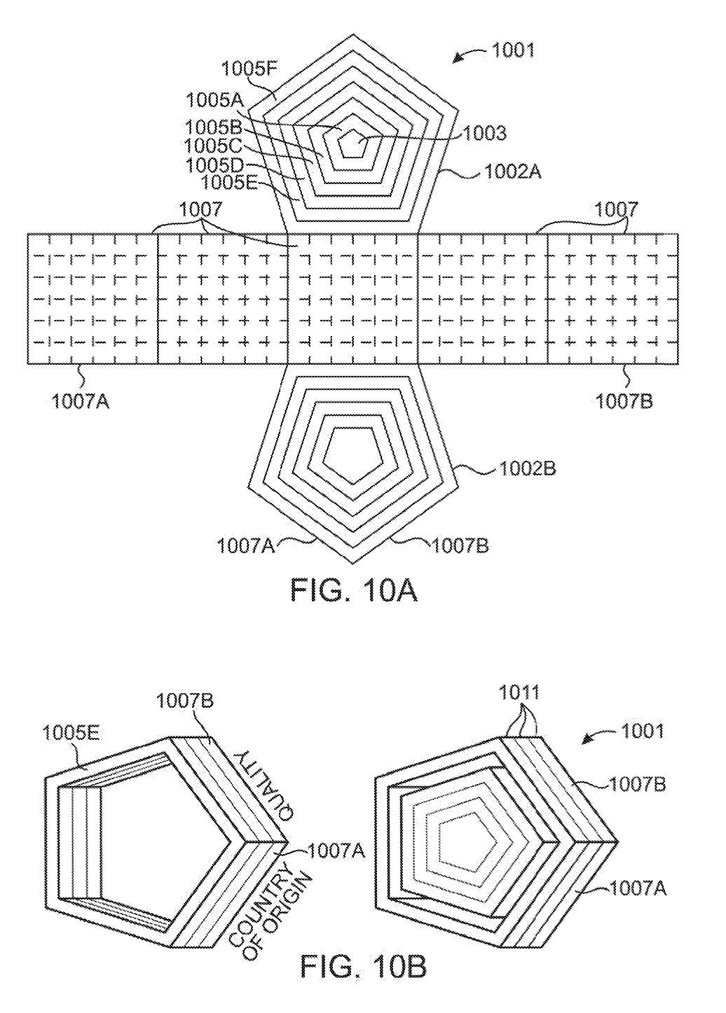

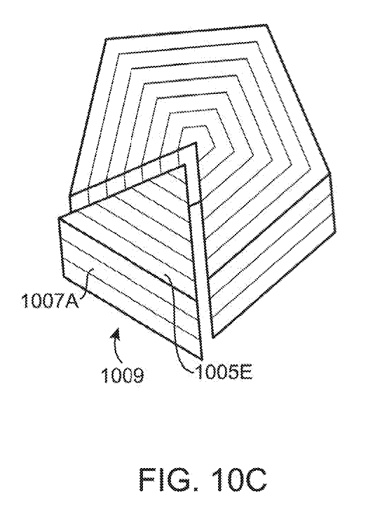

Such objects (902) have the advantage of simultaneously displaying all permutations, but can rapidly become both visually and conceptually complex in higher dimensions. It may generally be preferred to use a simpler display method for search results with high dimensionality. One such simpler display method is depicted in FIGS. 10A and 10B. In the depicted embodiment of FIG. 10, a six-dimensional search result is depicted as a pentagonal prism (1001). FIG. 10A depicts the faces of the prism (1001) in an exploded view to further clarify the permutations, and FIG. 10B depicts a partially exploded view of the prism (1001).

The depicted prism (1001) comprises a pentagonal base (1002A) with an opposing pentagonal top (1002B). Conceptually, the top (1002B) and base (1002A) each include a collinear central pole (1003) surrounded by a series of n (i.e., six) concentric pentagonal “rings” (1005A) to (1005F), coaxial to the pole (1003). The top (1002B) and base (1002A) represent one search dimension and each ring represents one category within the search dimension. The five side faces (1007) each represent the other five knowledge domains (205) (search dimensions). Each of the faces (1007) is comprised of a number of generally parallel, vertically stacked “floors” (1011) with each floor (1011) representing a category (207) within the knowledge domain (205) represented by the particular face (1007). The height of the prism (1001) by number of floors which are analogous to a unit block in the cube (702) illustration of FIGS. 5-9, is equal to the maximum number of categories (207), across all knowledge domains (205). It will be apparent to one skilled in the art that where a given knowledge domain (205) (face) has less than the maximum number of categories, certain floors will be empty with respect to that knowledge domain (205).

This embodiment may also be better understood by reference to an example. Continuing with the quinoa example of FIGS. 5-9, recall that the four knowledge domains (205A) to (205D) used in the prior examples were “country of origin” (205A), “quality” (205B), “retailer” (205C), and “brand” (205D). In the illustrative example of FIGS. 10A and 10B, a fifth and sixth dimension/knowledge domain may be included. In this illustrative example, the dimension/knowledge domain for the base/top (1002A) and (1002B) will be “brand” (205D), with the understanding that this is an arbitrary choice for purposes of this illustrative example. Further continuing this illustrative example, there will be six categories within the “brand” (205D) dimension. Thus, each of the concentric pentagonal “rings” (1005A) to (1005E) represents a category in the “brand” search dimension (205D). In this example, the second-outermost ring represents the “Goya” (207D-2) brand.

The outer (1007) faces represent other search dimensions (205). For example, in the depicted embodiment, face (1007A) represents the search dimension “country of origin” (205A) with three categories (Bolivia, Ecuador, Peru) and face (1007B) represents the search dimension “quality” (205B) with two categories (organic and non-organic). As can be seen in FIG. 10C, faces (1007A) and (1007B) effectively are each the base of a “wedge” of the prism, and each floor of the wedges intersects with each of the concentric rings (1005A) to (1005F). A “wedge” thus contains all permutations of the categories in the knowledge domain represented by the face, and the knowledge domain represented by the top/base (1002A) and (1002B). The plane of intersection within the wedge between a floor and a ring thus represents the permutation search for the categories represented by the floor and ring, respectively. That is, the portion of ring (1005E) contained in the wedge (1009) for the “country of origin” (205A) face (1007A) is essentially a rectangular plane or prism with the same number of floors (1011) as the face. Each floor of the ring (1005E) contained in the wedge (1011) represents the permutations of the top/base (1002A) and (1002B) dimension (2050) with the face (1007A) dimension (205A).

Turning to the specific domains and categories, in this illustrative example, the rings represent the “brand” dimension (205D), and second-outermost ring (1005E) represents the “Goya” brand category (207D-2). Wedge (1009) represents all permutations of knowledge domain “country of origin” (205A) because wedge (1009) has face (1007A), and face (1007A) corresponds in this illustrative example to that particular knowledge domain. This choice is arbitrary for purposes of the example.

The bottom floor (1011) of wedge (1009), and thus of the portion of each of the rings (1005A) to (1005E) in the wedge (1009), represents the first category (207A-1) in the “country of origin” knowledge domain (205A), or “Bolivia.” The middle floor (1011) represents “Peru” and the top floor represents “Ecuador.” Thus, the portion of concentric ring (1005E) within wedge (1009), identified in FIG. 10B as being associated with face (1007A), represents the permutations of the “country of origin” categories (207A) with “Goya.” Because “Goya” is one brand and there are three “country of origin” categories, there are three permutations in this section of ring (1005E). By clicking on the appropriate floor (1011), the user (401) can bring up the list of search results for that permutation, similar to clicking on a unit block of the cube (702) in FIG. 7.

It should be noted that since not all knowledge domains (205) will necessarily have the same number of categories (207), certain floors (1011) may be empty for certain wedges (1009). For example, for face (1007B), representing “quality” (205B), if there are only two categories (“organic” and “non-organic”), then only two floors (1011) are used, and the third is simply empty. The empty floor (1011) may be visually indicated, such as by omitting that portion of the structure (1001) from the visualization (1001), or by shading or another indicator that this portion of the visualization (1001) does not exist for lack of a category (not to be confused with a permutation for which there were no search results). Thus, the top floor (1011) of the wedge defined by face (1007A) is shaded in the depicted embodiment.

This same general structure (1001) can be used for an arbitrary number of dimensions, including a smaller number of dimensions. For example, in the depicted embodiment of FIGS. 10A, 10B, and 10C, if there were only four dimensions, two of the five faces would simply be blank or “empty,” and the floors (1011) in their wedges would represent nothing. For a larger number of dimensions, the geometric shape of the structure would increase. For example, for a nine-dimension search, the top (1002B) and base (1002A) would represent one dimension, and an octagonal prism would represent the other eight.

In this visualization, all permutations involving the dimension represented by the top/base are displayed, but permutations between or among faces are not. That is, there is no structure representing permutations of categories for the knowledge domains represented by two or more faces, no matter how situated. Thus, in such an embodiment, the user interface will generally comprise elements operable to allow the user (401) to specify which dimension will be represented by the top/base. Alternatively, the system may automatically select a dimension for the top/base to maximize or otherwise improve the information density of the visualization. For example, the server may, by default, use as the top/base dimension whichever knowledge domain (205) had the largest number of non-empty search sets in its permutation searches with the other dimensions. In a still further embodiment, the system may auto-select the top/base dimension based upon the number of categories in the search dimension to ensure that the number of concentric rings (i.e., categories) is not unwieldy in the visualization. Note that the element of the systems and methods which direct searches within rings, wedge, and floors in the depicted embodiment (e.g., a query builder module) is the same element that directs P_{1 . . . n} searches, as described elsewhere. The element of the systems and methods that transfers information used to construct the visualization of results is generally a different component (e.g., a results builder).

As previously indicated, and as with all visualizations described herein, the visualization (1001) may be manipulated using user interface (411) controls, which can cause the visualization (1001) to pan, zoom, and/or rotate. Also, the user (401) may omit one or more dimensions from the display entirely. This may be particularly useful where one dimension produces few or no search results, or where the user (401) simply wishes to simplify or declutter the display to focus on the interplay between a smaller number of dimensions. In such circumstances, the visualization (1001) may be re-rendered using an alternative visualization (1001) more appropriate for the number of dimensions and categories displayed.

The user interface (411) controls may also be operable for the user (401) to cause certain elements of the visualization (1001) to be separated or removed from the aggregate and examined individually. By way of example and not limitation, the user (401) may be able to select and separately view the top half of the cube (702) of FIG. 7, or may be able to select and view one of the concentric rings (105E) as shown in FIG. 10B.

The end result provides the user (401) with a multi-dimensional organizational framework for refining the search and understanding the results. By accessing an information structure which represents a body of knowledge, the user (401) can pick and choose the most relevant topics with ease. This takes information retrieval further than current methods insofar as information is structured within a body of knowledge created in collaboration with, and directed by, the searching human user (401). That is, the categorical framework imprinted upon the search result is established by the user (401) conducting the search, rather than by what is found in the database (409) being searched. Such flexibility will be especially useful and needed when dealing with highly complex databases such as, those dealing with the human genome and its interplay with the environment and disease manifestation/expression.

Because the information being structured and displayed comprises a body of knowledge distributed and displayed within categories (207), and because the user (401) is likely to desire to retrieve such information on multiple occasions over time, the interface (411) generally provides for a saving function which will rerun the same search with the citations/websites retrieved being automatically updated to the date of each such subsequent repeated search. Additionally, given that it can take time for the user (401) to construct the search, the ability to save the search progress is desirable, as it will reduce rework, and ensure that later searches are conducted using substantially similar, or identical, searching frameworks. This will save the user (401) from having to reconstruct the search from scratch every time. In embodiments where the search engine/database being accessed itself implements a saved search function, the systems and methods described here may alternatively use that pre-existing functionality. If not, this functionality may simply be implemented via the systems and methods described herein.

It is important to understand that the systems and methods described herein are not necessarily themselves search engines (409), but rather are interfaces and backend user translation/ordering/modeling, labeling, and P_{1 . . . n} sequencing operations that interact with search engines (409) as well as backend operations to effect/generate P_{1 . . . n} visualization along with the standardization processes that accompany such operation. It is further important to understand that because the results are driven by user-defined categories, the quality and pertinence of the search results may be correlated to how well the user (401) selects categories. As such, in an embodiment, the systems include a glossary of categories upon which the user (401) may rely when developing categories for the user-selected knowledge domains. Although the system (400) may not necessarily have any controlled vocabularies, it may rely upon a default vocabulary or available controlled vocabularies for the database or search engine (409) to which it is connected, or may further rely on user-identified frameworks (via the user interface) and provide the storage space for such, given that proper licensing and copyright protections are in place. In other words, the system (400) first shapes the search by the directions in its algorithm and translates search terms and Boolean operators into a search input (503), which is then, through backend operations, connected and provided to the user-selected search engine (409). Finally, the systems and methods provide a multi-dimensional display (702), (902) and (1001) of the search results retrieved from that database or search engine (409). This display allows for the display of the master search, as well as for the display of each of the simultaneous/sequential permutation searches that fill the cells, rings, planar surfaces, etc., of the polyhedric display product. This is done by first interfacing with the search engine (409) (e.g., via a query builder module) to structure the overall and permutation searches (601).

The systems and methods also take the information the search engine (409) has obtained from each of the simultaneous/sequential searches (601) and associates the information (e.g., via a results builder module) within the appropriate cell of the display (702). From such cell, it is then accessible by the user (401) through the user interface (411). Thus, the systems and methods may be adapted to the structure, scope, and limitations of a particular search engine (409). Generally speaking, the more robust the search engine (409), the more robust the results which can be obtained using the systems and methods described herein. This is because, among other things, robust databases (409) allow for more advanced search input (503), which means that the systems and methods described herein can in turn produce more advanced search input (503) and yield more advanced information retrieval recall and precision.

The interface (411) that produces the search input (503) also contains information on the knowledge domains that shape the search and its display. For example, the knowledge domain name itself is identified to shape the structure (dimensions) of the search on the back end and the display. As indicated, however, the knowledge domain names are not part of the search string itself. Rather, the information contained in the knowledge domains helps, in the back end, to organize the information for the sequencing (as used herein, meaning essentially to cause the needed queries to be executed, and not necessarily in any particular order) of multi-dimensional searches and its display. The display, whether text or graphic, allows the user (401) to access search string permutations from within the text or graphic display. This technique takes advantage of the human capacity for categorical thinking, which may drive the search engine results to a particular set of retrievals, which more closely match how the specific user (401) conducting the search conceptually organizes the different vectors of information that comprise the knowledge sought.

This has advantages, particularly in scientific, legal, and other hierarchical or taxonomical disciplines, where terms may have particular meanings which do not necessarily resemble common parlance. This can cause traditional searching to produce a large number of irrelevant results, when ranking (popularity of a search term) is used as a measure of relevance. For example, an attorney searching for information on secured transactions is generally looking for a specific type of legal document and transaction. However, a search engine, which derives categorical connections from associations developed from prior searching or connections, is likely to produce a large number of results that have nothing to do with what the searcher wants. For example, a search for “secured transactions” may turn up a large number of contacts for home security systems, or security guard agreements. This is because the majority of people searching the database, particularly a public database such as Google®, will be looking for these types of contracts when they use terms such as “secured” or “security.” Although using the interface described herein may impose some additional time in that the user (401) provides more than just a search term, on balance, this investment will be paid when the resulting search set is either devoid of irrelevant results, or such irrelevant results can be quickly identified and discarded, without the user (401) having to search through page after page of linearly presented search results.

In an embodiment, the results builder module may be additionally configured with an evaluative function implemented via the use of embodiment-specific metrics. By way of example and not limitation, distance and range metrics may be indicative of the probability that a given citation, document, or other retrieved search result contains information relevant to the user. However, the distance between words (in a search result), as a metric for relevance, is irrelevant if the words/terms/text returned do not meet the user's criteria for desired results, as indicated in the example provided immediately above. The relevance is, therefore, called into question. In a similar way, a search engine may return a very large range of topics, given the search terms entered by the user; but, the relevance of a large range is called into question if, within that range, the range of topics that do not directly meet the users needs is nearly as large. Other metrics may also be used to evaluate other aspects of a given third party search engine's performance or suitability to the particular search. By way of example and not limitation, metrics may be implemented to evaluate the search engine's effectiveness, such as precision and recall metrics, sometimes also referred to in the art as sensitivity and positive predictive value, particularly in the field of epidemiology. Unlike epidemiology's sensitivity and specificity measures, these measures do not have a gold standard search result against which competing search methods or competing search engines may be measurerd. Furthermore, each measure requires an unranked database [meaning: e.g. the search engine does not rank the results] from which retrieval occurs. If the database or the pool of documents from which retrieval is drawn is ranked, one recommended metric is to create a curve plotting precision against recall. Precision may be defined as follows. Within an unranked database, only a fraction of retrieved documents is deemed relevant. In this embodiment, users will be working with third party search engines, generally ranked. For the purposes to which users employ the system, a conditionally limited precision metric is presented here. This metric is configured to create a work-a-round for the problem presented in the lawyer example above. This conditionally limited precision metric is defined as follows: given documents retrieved as truly relevant, as indicated based on user input, by the third party search engine ranking, what proportion of the retrieval are deemed truly relevant by the user? This metric assumes that third party search engine ranking is the measure of relevance. It further assumes that the user may want to determine the precision involved in reviewing e.g., the first 10 third party search engine-ranked documents retrieved, the first 20, or the first 50 etc. If the third party ranked retrieval is valid for user purposes, then the user would find that the precision of the first 10 is higher than that of the first 20, or the first 50. Functionally, this is similar to researcher annotations; that is information that may be helpful to a researchers who wish to document searches conducted and how the results are assessed or utilized. This embodiment-specific metric, however, allows the user to quickly compare precision, albeit conditionally limited, among searches, when evaluating P_{1 . . . n} search results. This conditionally limited precision does not alter the relationship between precision and recall. For example, if the user limits the search to the retrieval with the highest conditionally limited precision rate, the denominator selected by the user may be so small that the user misses truly relevant articles that would have been retrieved had the denominator been larger. In other words, the inverse relationship between precision and recall stands, even in conditionally limited precision and recall settings. In this embodiment, users will have available a conditionally limited precision calculator. This may be an embodiment-specific metric and calculator. Recall measures the fraction of relevant items among the total relevant and irrelevant retrieved or, given that the citations were retrieved, what proportion were relevant.

In a further embodiment, an embodiment-specific metric is developed and named, a binomial tracking score for each search retrieved when searches are used to identify natural language data distributed within user predefined frameworks for, but not limited to: (1) large e-mail databases for corporate, institutional, administrative, governmental, and/or legal or medico-legal purposes; and/or (2) electronic health records for quality improvement, clinical, medico-legal, or research purposes. The assumption underlying this metric is that the user value of a document/citation is greater to the extent to which it includes a greater number of terms used in a search string. Let's say an agriculturist is looking for an automatic way of evaluating a user value of documents/citations on organic Bolivian quinoa sold to U.S. retailers, Trader Joe's and Whole Foods. Rather, than looking at citations within permutation searches, the agriculturist examines all terms in the master search string: quinoa AND (Bolivia OR Peru) AND (organic OR non-organic) AND (Trader Joe's OR Whole Foods), selecting quinoa, Bolivia, organic, Trader Joe's, Whole Foods. Once selected these five terms are distributed horizontally in a spreadsheet. Distributed vertically are all P_{1 . . . n} documents that contain the word Bolivia, as this is a country restricted search. For each docoument, a y/n per term response is checked, i.e., quinoa (y/n), organic (y/n), Trader Joe's (y/n), Whole Foods (y/n). Likewise for each document a score is derived. If the document scored four yes's, then its score is 100%, for three yes's 75%, for two yes's 50%, for one yes 25%, and for no yes's 0%. These are called binomial tracking scores. Documents with a higher score are considered to have a higher user value. The scores may then be ranked from, for example, high to low, and the agriculturist now has another new and embodiment-specific metric that serves as a method of evaluating the search (for example, by optionally calculating the proportion of documents retrieved with a binomial tracking score equal to or greater than 75%). In the process, the metric provides another way the automatic deconstruction of the search. Again, this new and embodiment-specific score is called the binomial tracking score. This score is functionally another type of researcher annotation, but based upon the master searches instead of, or addition to, permutation searches.

While the multi-dimensional display is generally polyhedral, it is not limited to polyhedral displays. Examples of other displays include, but are not limited to, matrices, quadrants, and tabular formats. The specific multi-dimensional display may vary from embodiment to embodiment, and a given embodiment may be configured to use a plurality of different multi-dimensional displays, depending upon, among other things, variations in user-provided input, such as, without limitation, the number of categories and/or domains indicated in the user-provided input.

Regardless of the specific display technique, corresponding weights per permutation are generally a function of the value assigned algorithmically based on the metrics used. Preferred metrics are precision and recall for unranked search results and their derivatives: harmonic mean measures (F and F1 scores) and mean average precision, of use with ranked results. These may be applied to the ranked retrieval within each permutation, with denominator size being preset at the number of retrievals. In an embodiment, other metrics may be alternatively or additionally implemented. One is the conditionally limited precision score. The other is the binomial tracking score, which may be used to target communications within electronic health records databases or other narrative text databases accessed for medical, legal, medico-legal purposes as well as for information retrieval and other research purposes.

These systems and methods transform the way the user interacts with a search engine and computer, the way the computer converts human information into computer algorithms, processes the information and relates to third party search engines, and the way the computer displays this information for a user. Rather than present information in a limited page-by-page fashion, search results are programmatically structured into a body of knowledge displayed via a multi-dimensional framework such that one or more permutations are accessible to the user through an interface, relying on computer-human interaction options, such as, but not necessarily limited to, clicking or highlighting, voice, eye movement, hand gestures, gyro mice, or three-dimensional interface modeling.

These systems and methods differ from the prior art in a number of ways, including without limitation: how a natural language search strategy or string uses multi-functional Boolean operators; how the search strategy actually enters and processes the data; how P_{1 . . . n} permutation searches are constructed and executed; how the search results are analyzed using new and embodiment-specific metrics; how P_{1 . . . n} are distributed within a multi-dimensional display; how search results are displayed; and how the search is handled and managed to achieve the objectives of the search and its display.

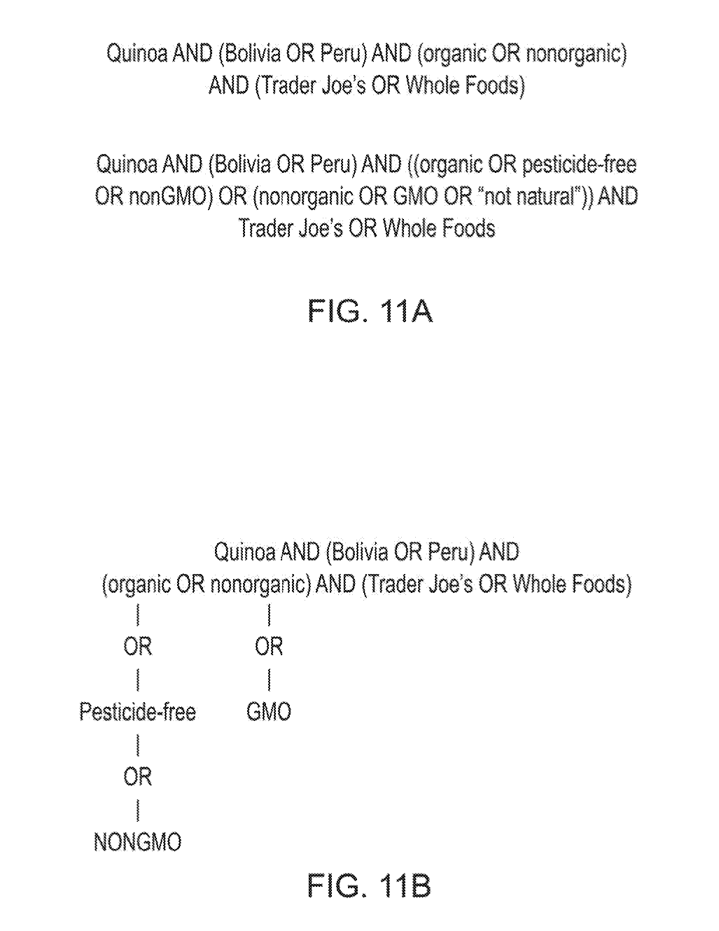

Boolean operator multi-functionality is not limited to the sequencing and display of P_{1 . . . n} searches and displays. The illustrative example in FIG. 11 demonstrates one search string example used in this application. In the depicted example of FIG. 11, the Boolean operators serve as connectors and they provide information on the number of domains and within-domain categories. Were synonyms needed, double parentheses may be used to indicate synonyms connected by OR, but this method is cumbersome and error prone for the developer within a multi-functional Boolean developer/coder environment. In the depicted method of denoting synonyms of FIG. 11 may not be intuitively interpretable for the multi-dimensional search software developer. An alternative way of illustrating the use of OR for synonym purposes is depicted in FIG. 12. In the depicted example of FIG. 12, horizontally distributed Boolean ORs are within-domain multi-functional Boolean ORs, and vertically distributed Boolean ORs connect synonyms. Vertical and horizontal lines are often used by software developers in the art in coding P_{1 . . . n} searches; however, only the horizontal lines are typically used in P_{1 . . . n} displays.

When the search is conducted within specific databases, each of the P_{1 . . . n} results will include additional information. For example, the PubMed or PubMed Commonsdatabases of the National Library of Medicine may return similar articles, related images, and/or database cross-indexing data. Similarly, legal databases may return headnotes, case citations, and secondary material cross-references. Similarly, when the Google Scholar search engine is used, each P_{1 . . . n} search is generally associated with Google Scholar recommended articles, citing articles, and/or related book content. Similarly, the Cochrane Library of systematic reviews and meta-analysis provides with each set of search results information on, for example, other reviews, trials, related methods, studies, technological assessments, and economic evaluations. The systems and methods described herein serves functionally as an adjunct to, and complement of, existing search engines.

One of ordinary skill in the art will be able to implement the aspects of the systems and methods described herein using programming languages and development platforms and frameworks known or later developed in the art suitable to the task. By way of example and not limitation, the user interface elements may be implemented using the Javascript programming language, HTML, and cascading style sheets (CSS). Common frameworks and libraries suitable for such development and known to one of ordinary skill include, without limitation, Angular, JQuery and Bootstrap. Elements of the move-view-controller architectural pattern for implementing user interfaces may also be implemented via these and other frameworks. Similarly, the display and visualization elements also utilize user interface principles and may be implemented using similar technologies. The multi-dimensional display aspects may be implemented using additional graphics management libraries, such as, but not limited to, OpenGL. HTML features such as scalable vector graphics may also or alternatively be used, as may any other suitable graphics library.

Also, by way of example and not limitation, the backend server software, including the query builder module, synonym builder, and results builder module, may be implemented in any suitable programming language or platform, including, without limitation, C, C++, Java, Python, Perl, and GO. Suitable platforms include Windows Server, Linux, Unix, MacOS, and any other server-grade operating system.

Described herein, among other things, is a computer-implemented method for generating a search string for a search engine comprising: receiving from a user an indication of a metatopic for a search; receiving from a user one or more indications of a knowledge domain; for each indication of a knowledge domain in said one or more indications of a knowledge domain; receiving from said user an indication of one or more categories for said each indicated knowledge domain; for each indication of a knowledge domain in said one or more indications of a knowledge domain; generating a search substring comprising each one of said user-indicated categories for said each indication of a knowledge domain joined by a Boolean OR operator; generating a search string comprising each one of said generated sub-search strings joined by a Boolean AND operator; transmitting said generated search string to said search engine.

Also described herein, among other things, is a computer-implemented method for generating a search string for a search engine comprising: receiving from a user an indication of a metatopic for a search; receiving from a user one or more indications of a knowledge domain; receiving from said user a total number of knowledge domains equaling the total number of Boolean AND operators in said search string, with the total number representing the number of categories and/or dimensions and/or faces of the resultant search display/visualization; for each indication of a knowledge domain in said one or more indications of a knowledge domain; receiving from said user an indication of one or more categories for said each indicated knowledge domain; receiving from said user a total number of categories within each knowledge domain equaling the total number of Boolean OR operators not enclosed in brackets, with the total number representing the number of categories/divisions/lines of thought/vectors within each knowledge domain for each indicated knowledge domain in said parallelity of indicated knowledge domains; generating a search substring comprising each one of said user-indicated categories for said each indicated knowledge domain joined by a Boolean OR operator; generating a search string comprising each one of said generated sub-search strings joined by a Boolean AND operator; transmitting said generated search string to said search engine.

While the invention has been disclosed in connection with certain preferred embodiments, this should not be taken as a limitation to all of the provided details. The intent of the invention is the use of known fiducial elements (tags) where connections between those elements represent data, and each fiducial element itself allows for the entering of additional data behind said fiducial element. Modifications and variations of the described embodiments may be made without departing from the spirit and scope of the invention, and other embodiments should be understood to be encompassed in the present disclosure as would be understood by those of ordinary skill in the art.

1. A computer-implemented method for generating a multi-dimensional visualization of a computer-aided database search result set comprising:
providing a user device;
providing a server computer;
providing a search engine;
receiving at said user device one or more indications of a knowledge domain;
for each received indication of a knowledge domain in said one or more indications of a knowledge domain;
receiving at said user device an indication of one or more categories for said each indication of a knowledge domain;
for each combination of said one of more received categories in said one or more received knowledge domains, said computer server generating a permutation search string having search criteria comprising said categories in said each combination;
executing each of said permutation search strings via said search engine;
for each of said executed permutation search strings, receiving at said computer server a corresponding search result set; and
displaying on a display of said user device a multi-dimensional visualization of said each corresponding search result set.

2. The method of claim 1, wherein said multi-dimensional visualization is a geometric object selected from the group consisting of: a polyhedron; a prism; an n-dimensional polytope.

3. The method of claim 2, wherein each axis of said geometric object corresponds to one of said one or more indicated knowledge domains.

4. The method of claim 3, wherein said geometric object comprises a plurality of cells, each one of said cells corresponding to one of said each corresponding search result sets.

5. The method of claim 4, wherein the number of said cells on said each axis is equal to the quantity of said one or more indicated categories for said one of said one or more indicated knowledge domains corresponding to said each axis.

6. The method of claim 5, further comprising:
in response to receiving at said user device a user action indicative of one cell in said plurality of cells, displaying at said user device said each corresponding search result set for said indicated one cell.

7. The method of claim 2, wherein said geometric object is an n-dimensional polytope and said n-dimensional polytope is a hypercube having n dimensions.

8. The method of claim 2, wherein said geometric object is an irregular polyhedron in the configuration of a prism having an n-sided base, where n corresponds to the quantity of knowledge domains in said one or more indicated knowledge domains.

9. A system configured to generate a multi-dimensional visualization of a computer-aided database search result set comprising:
a user device;
a server computer comprising a microprocessor and a non-transitory computer-readable storage medium having computer-readable instructions thereon which, when executed by said microprocessor, perform the steps of:
receiving via a telecommunications network from said user device data indicative of a plurality of user-supplied knowledge domains and, for each knowledge domain in said plurality of knowledge domains, a plurality of categories;
for each combination of categories in said plurality of categories in said plurality of knowledge domains, generating a permutation search string having search criteria comprising said categories in said each combination;
executing each of said permutation search strings via a search engine;
for each of said executed permutation search strings, receiving a corresponding search result set;
generating a data object comprising said each corresponding search result set, said data object configured to be displayed on said user device; and
transmitting said generated data object to said user device.

10. The system of claim 9, wherein said user device comprises a microprocessor and a non-transitory computer-readable storage medium having computer-readable instructions thereon which, when executed by said user device microprocessor, display said generated data object as a geometric object in a multi-dimensional visualization.

11. The system of claim 10, wherein said geometric object selected from the group consisting of: a polyhedron; a prism; an n-dimensional polytope.

12. The system of claim 11, wherein each axis of said geometric object corresponds to one of said plurality of knowledge domains.

13. The system of claim 12, wherein said geometric object comprises a plurality of cells, each one of said cells corresponding to one of said each corresponding search result sets.

14. The system of claim 13, wherein the number of said cells on said each axis is equal to the quantity of said one or more indicated categories for said one of said plurality of knowledge domains corresponding to said each axis.

15. The system of claim 14, wherein said user device instructions, when executed by said user device microprocessor, further perform the step of, in response to receiving at said user device a user action indicative of one cell in said plurality of cells, displaying at said user device said each corresponding search result set for said indicated one cell.

16. The system of claim 11, wherein said geometric object is an n-dimensional polytope and said n-dimensional polytope is a hypercube having n dimensions.

17. The system of claim 11, wherein said geometric object is an irregular polyhedron in the configuration of a prism having an n-sided base, where n corresponds to the quantity of knowledge domains in said one or more indicated knowledge domains.

18. A system configured to generate a multi-dimensional visualization of a computer-aided database search result set comprising:
a user input means;
a means for receiving from a user data indicative of a plurality of knowledge domains and, for each knowledge domain in said plurality of knowledge domains, a plurality of categories;
a means for generating a plurality of permutation search strings, each one of said plurality of permutation search strings being a different combination of categories in said plurality of categories in said plurality of knowledge domains;
a means for executing permutation search string in said plurality of permutation search strings via a search engine;
a means for receiving a plurality of search result sets, each search result set in said plurality of search result sets corresponding to one permutation search string in said plurality of permutation search strings; and
a means for displaying a multi-dimensional visualization of said plurality of search result sets to a user.

19. The system of claim 18, wherein said multi-dimensional visualization is a geometric object selected from the group consisting of: a polyhedron; a prism; an n-dimensional polytope.

20. The system of claim 19, wherein:
said geometric object comprises a plurality of cells, each one of said cells corresponding to one of said each corresponding search result sets;
each axis of said geometric object corresponds to one of said plurality of knowledge domains; and
the number of said cells on said each axis is equal to the quantity of said plurality of categories for said one of said plurality of knowledge domains corresponding to said each axis.
